(19) United States
(12) Patent Application Publication
(10) Pub. No.: US 2026/0177674 A1
(43) Pub. Date: Jun. 25, 2026

(54) TIME-OF-FLIGHT SENSOR AND METHOD OF OPERATING THE SAME

(71) Applicant: Samsung Electronics Co., Ltd., Suwon-si (KR)

(72) Inventors: Seunghyun Lee, Suwon-si (KR); Younggu Jin, Suwon-si (KR)

(21) Appl. No.: 19/383,340

(22) Filed: Nov. 7, 2025

(30) Foreign Application Priority Data
Dec. 19, 2024 (KR) 10-2024-0190669

(51) Int. Cl. G01S 7/4863; G01S 7/4865; G01S 7/489; G01S 17/10; G01S 17/894; H04N 25/616; H04N 25/705

(52) U.S. Cl. CPC G01S 7/4863; G01S 7/4865; G01S 7/489; G01S 17/10; G01S 17/894; H04N 25/616; H04N 25/705

(57) ABSTRACT

A sensor includes a depth pixel including a plurality of taps configured to operate based on demodulation signals having different phases, and each tap includes a first transfer gate, a storage gate and a second transfer gate that are sequentially arranged between a photodiode and a floating diffusion region. A first data sampling operation corresponding to a first conversion gain is performed by applying a turn-off voltage to the second transfer gate to set a capacitance of the floating diffusion region to a first capacitance. A second data sampling operation corresponding to a second conversion gain smaller than the first conversion gain is performed by applying the turn-off voltage to the storage gate and applying a turn-on voltage to the second transfer gate to increase the capacitance of the floating diffusion region to a second capacitance greater than the first capacitance.

### CROSS-REFERENCE TO RELATED APPLICATION(S)

This U.S. non-provisional application claims priority under 35 USC § 119 to Korean Patent Application No. 10-2024-0190669, filed on Dec. 19, 2024, in the Korean Intellectual Property Office (KIPO), the disclosure of which is incorporated by reference herein in its entirety.

### BACKGROUND

### 1. Technical Field

Example embodiments relate generally to semiconductor integrated circuits, and more particularly to a time-of-flight (ToF) sensor and a method of a ToF sensor.

### 2. Discussion of the Related Art

Recently, as interest in three-dimensional sensing to acquire three-dimensional information of objects has increased, various types of three-dimensional cameras have been developed. Among the various types of three-dimensional cameras, time-of-flight (ToF) cameras have been widely used due to their low circuit complexity and excellent distance resolution.

To extract distance information, a time-of-flight sensor uses a separate light source, such as a laser or light-emitting diode (LED), to illuminate an object with modulated transmitted light, and then calculates the distance by measuring the time difference or phase difference of the reflected light. The signal reflected back from the object is measured using demodulation signals. When the conversion gain of the depth pixels in the ToF sensor is changed to extend the sensing range, the size of the ToF sensor may increase. Therefore, it is desirable for the sensing range to extend without increasing the size of the ToF sensor.

### SUMMARY

Various example embodiments may provide a time-of-flight (ToF) sensor and a method of operating a ToF sensor, capable of efficiently changing a conversion gain of a depth pixel.

According to example embodiments, a method of operating a time-of-flight (ToF) sensor includes collecting photo charge, transferring the collected photo charge, and performing first and second data sampling operations. The ToF sensor includes a depth pixel including a plurality of taps configured to operate based on a plurality of demodulation signals having different phases. Each tap includes a first transfer gate, a storage gate and a second transfer gate that are sequentially arranged between a photodiode and a floating diffusion region. The photo charge is collected in a charge storage structure below the storage gate from the photodiode, and transferred the collected photo charge from the charge storage structure to the floating diffusion region. The first data sampling operation corresponding to a first conversion gain is performed by applying a turn-off voltage to the second transfer gate to set a capacitance of the floating diffusion region to a first capacitance. The second data sampling operation corresponding to a second conversion gain smaller than the first conversion gain is performed by applying the turn-off voltage to the storage gate and applying a turn-on voltage to the second transfer gate to increase the capacitance of the floating diffusion region to a second capacitance greater than the first capacitance. The performing of each of the first and second data sampling operations includes sensing the photo charge stored in the floating diffusion region as a signal voltage.

According to example embodiments, a time-of-flight (ToF) sensor includes a light source configured to emit a transmission light to an object, a pixel array including a depth pixel, and a row scanning circuit.

The depth pixel includes a plurality of taps configured to operate based on a plurality of demodulation signals having different phases with respect to a phase of the transmission light, and a tap of the plurality of taps including a first transfer gate, a storage gate and a second transfer gate that are sequentially arranged between a photodiode and a floating diffusion region. The row scanning circuit collects photo charge in a charge storage structure below the storage gate from the photodiode, transfers the collected photo charge from the charge storage structure to the floating diffusion region, performs a first data sampling operation corresponding to a first conversion gain by applying a turn-off voltage to the second transfer gate to set a capacitance of the floating diffusion region to a first capacitance, and performs a second data sampling operation corresponding to a second conversion gain smaller than the first conversion gain by applying the turn-off voltage to the storage gate and applying a turn-on voltage to the second transfer gate to increase the capacitance of the floating diffusion region to a second capacitance greater than the first capacitance. The row scanning circuit further senses the photo charge stored in the floating diffusion region as a signal voltage during the first and second data sampling operations.

According to example embodiments, a method of operating a time-of-flight (ToF) sensor includes changing a capacitance of the floating diffusion region by controlling voltages applied to the storage gate and the second transfer gate, and performing a plurality of sampling operations corresponding to a plurality of conversion gains with changing the capacitance of the floating diffusion region. The ToF sensor includes a depth pixel including a plurality of taps configured to operate based on a plurality of demodulation signals having different phases with each other. Each tap includes a first transfer gate, a storage gate and a second transfer gate that are sequentially arranged between a photodiode and a floating diffusion region. Each tab has one or more conversion gains.

The ToF sensor and the method of operating the ToF sensor according to example embodiments may efficiently implement the plurality of conversion gains without increase in the occupation area of the depth pixel and the ToF sensor by controlling the signals or voltages applied to the depth pixel to change the capacitance of the floating diffusion region.

### BRIEF DESCRIPTION OF THE DRAWINGS

Example embodiments of the present disclosure will be more clearly understood from the following detailed description taken in conjunction with the accompanying drawings.

FIG. 1 is a flowchart illustrating a method of operating a ToF sensor according to example embodiments.

FIG. 2 is a cross-sectional diagram illustrating a structure corresponding to one tab of a depth pixel included in a time-of-flight (ToF) sensor according to example embodiments.

FIG. 3 is a diagram illustrating implementations of a plurality of conversion gains in a method of operating a ToF sensor according to example embodiments.

FIG. 4 is a block diagram illustrating a ToF sensor according to example embodiments.

FIGS. 5 and 6 are diagrams for describing a method of measuring and calculating a distance to an object according to example embodiments.

FIG. 7 is a circuit diagram illustrating a depth pixel having a two-tap structure included in a ToF sensor according to example embodiments.

FIG. 8 is a timing diagram illustrating an operation of the ToF sensor including the depth pixel of FIG. 7 according to example embodiments.

FIG. 9 is a timing diagram illustrating a first sampling operation of a ToF sensor according to example embodiments.

FIGS. 10 through 12 are diagrams illustrating applied voltages and a potential profile according to the first sampling operation of FIG. 9 according to example embodiments.

FIG. 13 is a timing diagram illustrating a second sampling operation of a ToF sensor according to example embodiments.

FIGS. 14 through 16 are diagrams illustrating applied voltages and a potential profile according to the second sampling operation of FIG. 13 according to example embodiments.

FIG. 17 is a timing diagram illustrating a third sampling operation of a ToF sensor according to example embodiments.

FIGS. 18 and 19 are diagrams illustrating applied voltages and a potential profile according to the third sampling operation of FIG. 17 according to example embodiments.

FIG. 20 is a timing diagram illustrating a double sampling operation of a ToF sensor according to example embodiments.

FIGS. 21 and 24 are diagrams illustrating applied voltages and a potential profile according to the double sampling operation of FIG. 20 according to example embodiments.

FIG. 25 is a timing diagram illustrating a triple sampling operation of a ToF sensor according to example embodiments.

FIGS. 26 and 31 are diagrams illustrating applied voltages and a potential profile according to the triple sampling operation of FIG. 25 according to example embodiments.

FIG. 32 is a timing diagram illustrating a triple sampling operation of a ToF sensor according to example embodiments.

FIGS. 33 and 38 are diagrams illustrating applied voltages and a potential profile according to the triple sampling operation of FIG. 32 according to example embodiments.

FIG. 39 is a diagram illustrating sampling operations applicable to a depth pixel having a two-tap structure included in a ToF sensor according to example embodiments.

FIG. 40 is a circuit diagram illustrating a depth pixel having a two-tap structure included in a ToF sensor according to example embodiments.

FIG. 41 is a timing diagram illustrating an operation of the ToF sensor including the depth pixel of FIG. 40 according to example embodiments.

FIG. 42 is a diagram illustrating a layout of the depth pixel of FIG. 40 according to example embodiments.

FIGS. 43 and 44 are circuit diagrams illustrating a depth pixel having a four-tap structure included in a ToF sensor according to example embodiments.

FIG. 45 is a timing diagram illustrating an operation of the ToF sensor including the depth pixel of FIG. 44 according to example embodiments.

FIG. 46 is a diagram illustrating an layout of the depth pixel of FIG. 44 according to example embodiments.

FIG. 47 is a diagram illustrating sampling operations applicable to a depth pixel having a four-tap structure included in a ToF sensor according to example embodiments.

FIG. 48 is a diagram illustrating sharing a floating diffusion region of depth pixels included in a ToF sensor according to example embodiments.

### DETAILED DESCRIPTION OF THE EXAMPLE EMBODIMENTS

Various example embodiments will be described more fully hereinafter with reference to the accompanying drawings, in which some example embodiments are shown. In the drawings, like numerals refer to like elements throughout. The repeated descriptions may be omitted.

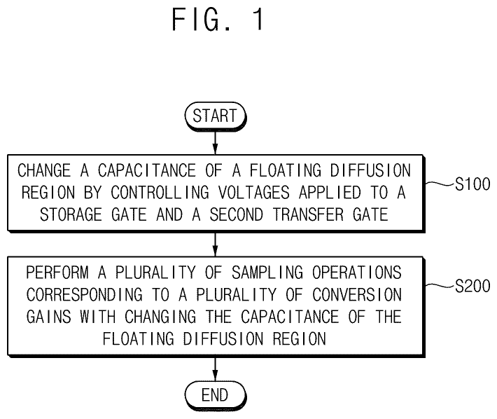

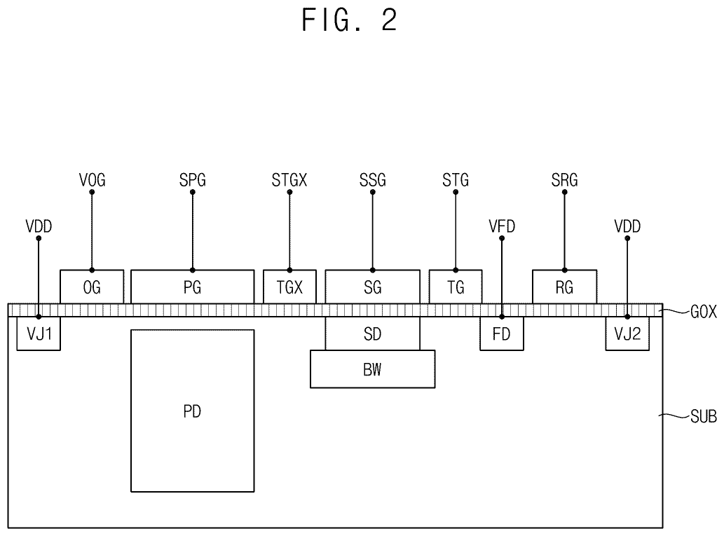

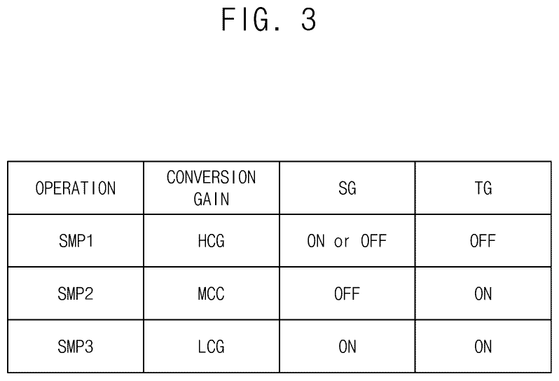

FIG. 1 is a flowchart illustrating a method of operating a ToF sensor according to example embodiments, and FIG. 2 is a cross-sectional diagram illustrating a structure corresponding to one tab of a depth pixel included in a time-of-flight (ToF) sensor according to example embodiments.

FIG. 1 illustrates a method of operating a ToF sensor including one or more depth pixels. The depth pixel includes a plurality of taps that operate based on a plurality of demodulation signals having different phases. As will be described below, the depth pixel may be a two-tap structure including two taps or a four-tap structure including four taps, but the present invention is not limited thereto.

Each tap of the plurality of taps includes a first transfer gate, a storage gate, and a second transfer gate that are arranged sequentially between the photodiode and the floating diffusion region. Referring first to FIG. 2, a basic tap structure of a depth pixel will be described.

Referring to FIG. 2, impurity regions such as a photodiode PD, a floating diffusion region FD, voltage junctions VJ1 and VJ2, a storage diode SD, and a buried well BW may be formed in a semiconductor substrate SUB. When the semiconductor substrate SUB is P-type, the photodiode PD, the storage diode SD, the floating diffusion region FD, and the voltage junctions VJ1 and VJ2 may be formed by doping N-type impurities. The floating diffusion region FD and voltage junctions VJ1 and VJ2 may be doped with a higher concentration relative to the photodiode PD and the storage diode SD. The buried well BW may be formed by doping with P-type impurities to prevent or reduce charge flow from the semiconductor substrate SUB to the storage diode SD. The voltage junctions VJ1 and VJ2 may be applied with a constant DC voltage, such as a power supply voltage VDD.

A gate insulating layer GOX is formed on the surface of the semiconductor substrate SUB, and gate structures such as an overflow gate OG, a photogate PG, a first transfer gate TGX, a storage gate SG, a second transfer gate TG, and a reset gate RG may be formed on the gate insulating layer GOX. The first transfer gate TGX may be referred to as a demodulation transfer gate TGX and the second transfer gate TG may be referred to as an FD transfer gate TG.

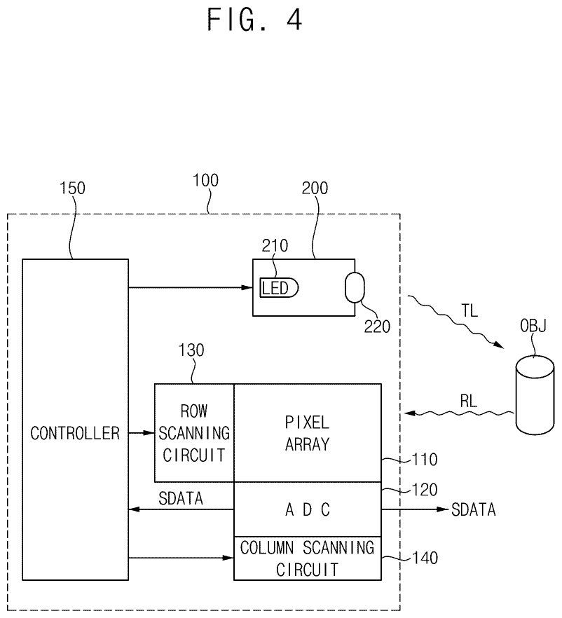

An overflow gate voltage VOG may be applied to the overflow gate OG, a photogate signal SPG may be applied to the photogate PG, a demodulation transfer control signal STGX may be applied to the first transfer gate TGX, a storage control signal SSG may be applied to the storage gate SG, an FD transfer control signal STG may be applied to the second transfer gate TG, and a reset signal SRG may be applied to the reset gate RG. The signals may be generated and provided by a row scanning circuit 130 as will be described below with reference to FIG. 4.

The photoelectric charge collected in the photodiode PD may be transferred to the floating diffusion region FD under the control of the row scanning circuit 130, and output a voltage VFD of the floating diffusion region FD.

As shown in FIG. 2, the first transfer gate TGX, the storage gate SG, and the second transfer gate TG may be sequentially disposed between the photodiode PD and the floating diffusion region FD.

Referring to FIGS. 1 and 2, a capacitance of the floating diffusion region FD may be changed by controlling voltages applied to the storage gate SG and the second transfer gate TG (S100).

Further, a plurality of sampling operations corresponding to a plurality of conversion gains may be performed with changing the capacitance of the floating diffusion region FD (S200).

Hereinafter, example embodiments of the method of FIG. 2 will be described with reference to corresponding drawings.

FIG. 3 is a diagram illustrating implementations of a plurality of conversion gains in a method of operating a ToF sensor according to example embodiments.

Referring to FIG. 3, the plurality of sampling operations of FIG. 1 may include a first sampling operation SMP1, a second sampling operation SMP2, and a third sampling operation SMP3.

According to the first sampling operation SMP1, the second transfer gate TG may be turned off (OFF) to set the capacitance of the floating diffusion region FD to a first capacitance to provide a first conversion gain. The storage gate SG may be turned off or turned on, which affects substantially no influence on the capacitance of the floating diffusion region FD because the second transfer gate TG is turned off.

According to the second sampling operation SMP2, the storage gate SG may be turned off and the second transfer gate TG may be turned on (ON) to increase the capacitance of the floating diffusion region FD to a second capacitance greater than the first capacitance to provide a second conversion gain smaller than the first conversion gain.

According to the third sampling operation SMP3, the storage gate SG and the second transfer gate TG may be turned on to increase the capacitance of the floating diffusion region FD to a third capacitance greater than the second capacitance to provide a third conversion gain smaller than the second conversion gain.

Conventionally, additional capacitors and switches are used to increase the capacitance of the floating diffusion region FD. These additional capacitors and switches increase the size of the depth pixel and the ToF sensor and reduce design margins.

According to example embodiments, the capacitance of the floating diffusion region FD may be increased by utilizing the lower regions of the storage gate SG and second transfer gate TG, thereby reducing the conversion gain.

As such, the ToF sensor and the method of operating the ToF sensor according to example embodiments may efficiently implement the plurality of conversion gains without increase in the occupation area of the depth pixel and the ToF sensor by controlling the signals or voltages applied to the depth pixels to change the capacitance of the floating diffusion region.

FIG. 4 is a block diagram illustrating a ToF sensor according to example embodiments.

Referring to FIG. 4, a ToF sensor 100 includes a sensing unit (sensor), a controller 150 and a light source module 200.

The sensing unit may include a pixel array 110, an analog-to-digital converter (ADC) unit 120, a row scanning circuit 130, and a column scanning circuit 140. The pixel array 110 may include one or more depth pixels that receive light RL reflected from an object OBJ. The light reflected from the object OBJ is based on light transmitted to the object OBJ from the light source module 200. The depth pixels may convert the reception light RL to electrical signals. The depth pixels may then provide information about a distance between the object OBJ and the ToF sensor 100. Furthermore, the depth pixels may provide information about Black-and-white image corresponding to the object OBJ.

In an example embodiment, the pixel array 110 may further include color pixels for providing color image information. In this case, the ToF sensor 100 may be a three-dimensional color image sensor that provides the color image information and depth information. According to example embodiments, an infrared filter and/or a near-infrared filter may be formed on the depth pixels and a color filter (e.g., red, green and blue filters) may be formed on the color pixels. According to example embodiments, the ratio of the number of the depth pixels to the number of the color pixels may vary as desired or by design.

The ADC unit 120 may convert an analog signal output from the pixel array 110 to a digital signal. According to example embodiments, the ADC unit 120 may perform a column analog-to-digital conversion that converts analog signals in parallel using a plurality of analog-to-digital converters respectively coupled to a plurality of column lines. According to example embodiments, the ADC unit 120 may perform a single analog-to-digital conversion that sequentially converts the analog signals using a single analog-to-digital converter.

According to example embodiments, the ADC unit 120 may include a correlated double sampling (CDS) unit for extracting an effective signal component. In some example embodiments, the CDS unit may perform an analog double sampling that extracts an effective signal component based on the difference between an analog reset signal including a reset component and an analog data signal including a signal component. In some example embodiments, the CDS unit may perform a digital double sampling that converts the analog reset signal and the analog data signal to two digital signals and extracts the effective signal component based on a difference between the two digital signals. In some example embodiments, the CDS unit may perform a dual correlated double sampling that performs both the analog double sampling and the digital double sampling.

The row scanning circuit 130 may receive control signals from the controller 150, and may control a row address and a row scan of the pixel array 110. To select a row line among a plurality of row lines, the row scanning circuit 130 may apply a signal for activating the selected row line to the pixel array 110. According to example embodiments, the row scanning circuit 130 may include a row decoder that selects a row line of the pixel array 110 and a row driver that applies a signal for activating the selected row line.

The column scanning circuit 140 may receive control signals from the controller 150, and may control a column address and a column scan of the pixel array 110. The column scanning circuit 140 may output a digital output signal received from the ADC unit 120 to a digital signal processing circuit (not shown) and/or to an external host (not shown). For example, the column scanning circuit 140 may provide the ADC unit 120 with a horizontal scan control signal to sequentially select a plurality of analog-to-digital converters in the ADC unit 120.

The controller 150 may control the ADC unit 120, the row scanning circuit 130, the column scanning circuit 140, and the light source module 200. The controller 150 may provide the ADC unit 120, the row scanning circuit 130, the column scanning circuit 140, and the light source module 200 with control signals, such as at least one of a clock signal, a timing control signal, and another signal. The controller 150 may include at least one of a control logic circuit, a phase locked loop circuit, a timing control circuit, a communication interface circuit, and another circuit.

The light source module 200 may emit light of a desired (or predetermined) wavelength. For example, the light source module 200 may emit infrared light and/or near-infrared light. The light source module 200 may include a light source 210 and a lens 220. The light source 210 may be controlled by the controller 150 to emit the transmission light TL of a desired intensity and/or characteristic (for example, periodic). For example, the intensity and/or characteristic of the transmission light TL may be controlled such that the transmission light TL has a predetermined, waveform, e.g., a pulsed wave, a sine wave, a cosine wave, or another type of wave. The light source 210 may be implemented by a light emitting diode (LED), a laser diode, or another type of light source.

Normal operation of the ToF sensor 100 according to example embodiments will now be described below.

The controller 150 may control the light source module 200 to emit transmission light TL having a periodic intensity. The transmission light TL emitted from the light source module 200 may be reflected from the object OBJ back to the ToF sensor 100 as reception light RL. The reception light RL may be incident on the depth pixels, and the depth pixels may be activated by the row scanning circuit 130 to output analog signals corresponding to the reception light RL. The ADC unit 120 may convert the analog signals output from the depth pixels to sampled data SDATA. The sampled data SDATA may be provided to the controller 150 from the column scanning circuit 140 and/or the ADC 120.

The controller 150 (or an external processor) may calculate the distance between the object OBJ and the ToF sensor 100, a horizontal position of the object OBJ, a vertical position of the object OBJ, and/or a size of the object OBJ based on the sampled data SDATA. The controller 150 may control the emission angle or a projection (or incident) region of the transmission light TL based on the distance, the horizontal position, the vertical position and/or the size of the object OBJ. For example, the controller 150 may control an interval between the light source 210 and the lens 220, a relative position (or a placement) of the light source 210 and the lens 220 with respect to each other, a refractive index of the lens 220, a curvature of the lens 220, or another feature of lens 220.

The transmission light TL illuminated to the object OBJ may be reflected, and the reflected light (e.g., reception light RL) may be incident on the depth pixels in the pixel array 110. The depth pixels may output analog signals corresponding to the reception light RL, the ADC unit 120 may convert the analog signals to digital data or the sampled data SDATA. The sampled data SDATA and/or the depth information may be provided to the controller 150, the digital signal processing circuit and/or the external host. According to example embodiments, the pixel array 110 may include color pixels, and color image information as well as the depth information may be provided to the digital signal processing circuit and/or the external host.

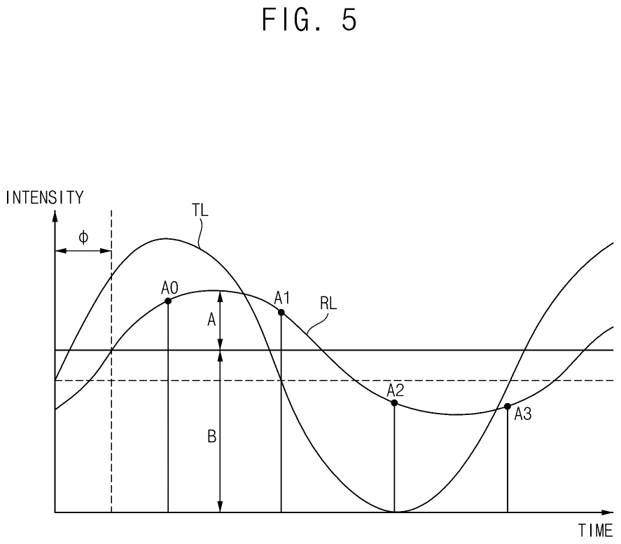

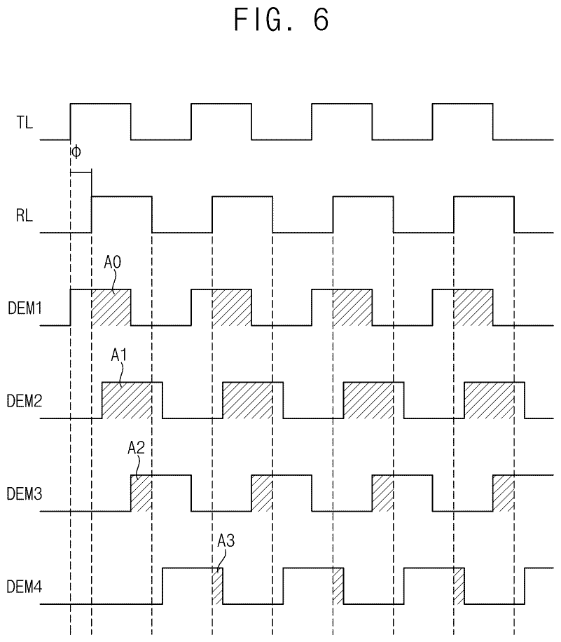

FIGS. 5 and 6 are diagrams for describing a method of measuring and calculating a distance to an object according to example embodiments.

Referring to FIGS. 4, 5 and 6, the transmission light TL emitted from the light source module 200 may have a (e.g., predetermined) periodic intensity and/or characteristic. For example, the intensity (e.g., number of photons per unit area) of the transmission light TL may have a predetermined waveform, which in this example is a sine wave but may be a different type of waveform in another example embodiment.

The transmission light TL emitted from the light source module 200 may be reflected from the object OBJ and then may fall incident on the pixel array 110 as reception light RL. The pixel array 110 may periodically sample the reception light RL. According to example embodiments, during each period of the reception light RL (which, for example, may correspond to a period of the transmitted light TL), the pixel array 110 may perform a sampling on the reception light RL by sampling, for example, at two sampling points having a predetermined phase difference (e.g., about 180 degrees), at four sampling points having a phase difference (e.g., of about 90 degrees), or at more than four sampling points. For example, the pixel array 110 may extract four samples A0, A1, A2 and A3 of the reception light RL at phases of 0 degree, 90 degrees, 180 degrees and 270 degrees of the transmitted light TL per period, respectively. Referring to FIG. 6, the pixel array 110 may extract the four samples A0, A1, A2 and A3 of the reception light RL by demodulation signals DEM1 to DEM4 having different phases with each other. In an embodiment, the demodulation signals DEM1 to DEM4 may be provided from the controller 150.

The reception light RL may have an offset B that is different from an offset of the transmission light TL emitted from light source module 200 due to background light, noise, and/or other effects. The offset B of the reception light RL may be calculated based on Equation 1.

$$B = \frac{A 0 + A 1 + A 2 + A 3}{4} \qquad [ Equation 1 ]$$

In Equation 1, A0 represents intensity of the reception light RL sampled at a phase of about 0 degrees of the emitted light TL, A1 represents intensity of the reception light RL sampled at a phase of about 90 degrees of the emitted light TL, A2 represents intensity of the reception light RL sampled at a phase of about 180 degrees of the emitted light TL, and A3 represents intensity of the reception light RL sampled at a phase of about 270 degrees of the emitted light TL.

The reception light RL may have amplitude A lower than that of the transmission light TL emitted from the light source module 200 due to loss (for example, light loss). The amplitude A of the reception light RL may be calculated based on Equation 2.

$$A = \frac{\sqrt{{( A 0 - A 2 )}^{2} + {( A 1 - A 3 )}^{2}}}{2} \qquad [ Equation 2 ]$$

Black-and-white image information corresponding to the object OBJ may be provided from respective depth pixels in the pixel array 110 based on the amplitude A of the reception light RL.

The reception light RL may be delayed by a phase difference Φ corresponding, for example, to twice the distance between the object OBJ and the ToF sensor 100 with respect to the emitted light TL. The phase difference Φ between the emitted light TL and the reception light RL may be calculated based on Equation 3.

$$ϕ = arctan ( \frac{A 0 - A 2}{A 1 - A 3} ) \qquad [ Equation 3 ]$$

The phase difference Φ between the emitted light TL and the reception light RL may, for example, correspond to a time-of-flight (ToF). In an example embodiment, the distance between the object OBJ and the ToF sensor 100 may be calculated by the following equation: R=c*ToF/2, where R represents the calculated distance and c represents the velocity of light. Further, the distance between the object OBJ and the ToF sensor 100 may also be calculated based on Equation 4 using the phase difference Φ between the emitted light TL and reception light RL.

$$R = \frac{c}{4 π f} ϕ \qquad [ Equation 4 ]$$

In Equation 4, f represents a modulation frequency, which, for example, may be the frequency of the intensity of the emitted light TL or the frequency of the intensity of the reception light RL.

Although FIG. 5 illustrates the transmission light TL of which the intensity has a waveform of a sine wave, it is understood that the present invention is not limited thereto. For example, the ToF sensor 100 may use the transmission light TL of which the intensity has various types of waveforms, according to example embodiments. Further, the ToF sensor 100 may extract the depth information according to the waveform of the intensity of the transmission light TL, a structure of a depth pixel, or the like.

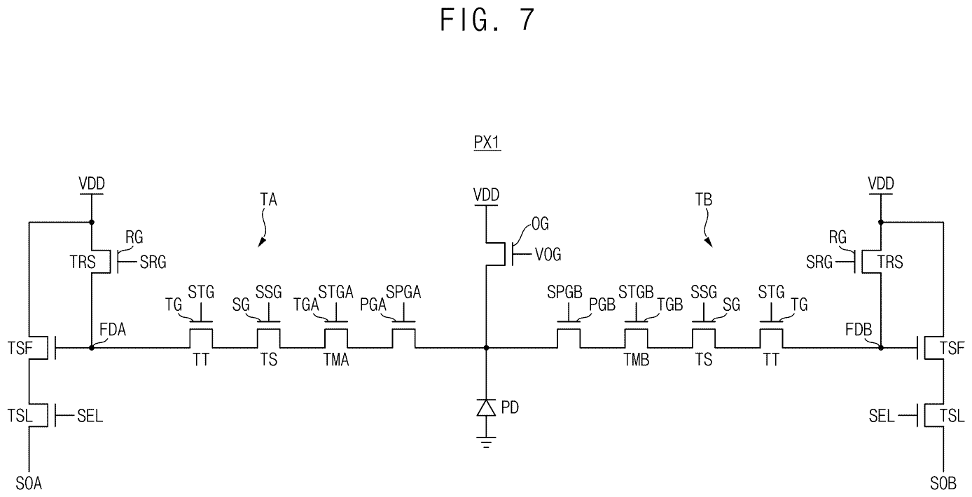

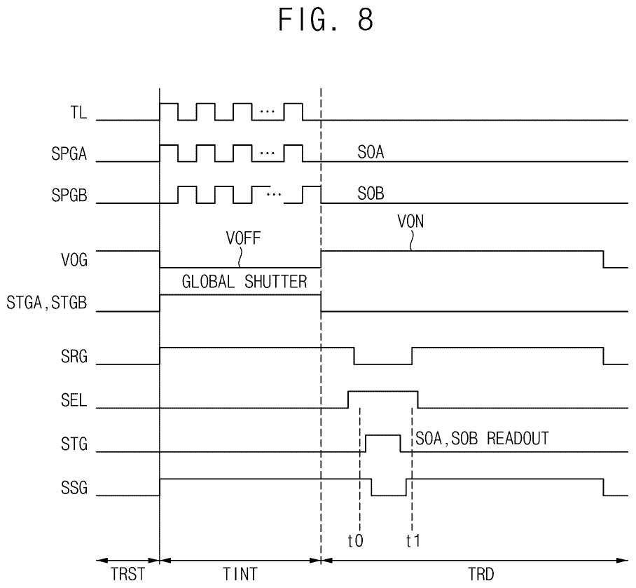

FIG. 7 is a circuit diagram illustrating a depth pixel having a two-tap structure included in a ToF sensor according to example embodiments, and FIG. 8 is a timing diagram illustrating an operation of the ToF sensor including the depth pixel of FIG. 7 according to example embodiments. FIG. 7 illustrates a two-tap structure where respective photogates are applied per tap.

Referring to FIG. 7, a depth pixel PX1 may include a first photogate PGA and transistors TMA, TS and TT corresponding to the first tap TA, a second photogate PGB and transistors TMB, TS and TT corresponding to the second tap TB, transistors TRS, TSF and TSL corresponding to readout circuits, an overflow gate OG and a photodiode PD. Each of the transistors TMA, TMB, TS, TT and TRS may include a gate disposed above a semiconductor substrate and source and drain regions disposed at both sides of the gate in the semiconductor substrate. The gates of the transistors TMA, TMB, TS, TT and TRS correspond to a first demodulation transfer gate TGA, a second demodulation transfer gate TGB, storage gates SG, and FD transfer gates TG and reset gates RG, respectively. Each of the first demodulation transfer gate TGA and the second demodulation transfer gate TGB may correspond to the first transfer gate TGX of FIG. 2.

A first photogate signal SPGA is applied to the first photogate PGA, a second photogate signal SPGB is applied to the second photogate PGB, a first demodulation transfer control signal STGA is applied to the first demodulation transfer gate TGA, a second demodulation transfer control signal STGB is applied to the second demodulation transfer gate TGB, an overflow gate voltage VOG is applied to the overflow gate OG, a storage control signal SSG is applied to the storage gates SG, an FD transfer control signal STG is applied to the FD transfer gates TG, a reset signal SRG is applied to the reset gates RG, and a selection signal SEL is applied to the gates of the selection transistors TSL. The first photogate signal SPGA and the second photogate signal SPGB, which have different phases, correspond to the demodulation signals described above. The first and second photogate signals SPGA and SPGB may be referred to as first and second demodulation signals, respectively. Each of the first demodulation transfer control signal STGA and the second demodulation transfer control signal STGB may correspond to the demodulation transfer control signal STGX of FIG. 2.

The first and second demodulation signals SPGA and SPGB, the first and second demodulation transfer control signals STGA and STGB, the overflow gate voltage VOG, the storage control signal SSG, the FD transfer control signal STG, the reset signal SRG, and the selection signal SEL may be provided from the row scanning circuit 130 under control of the controller 150, for example, as described with reference to FIG. 4.

The transistors TS including storage gates SG are one of charge storing structures that temporarily store the photo charge transferred from the photodiode PD through the transistors TMA and TMB including the first and second demodulation transfer gates TGA and TGB before transferring the photo charge to the floating diffusion regions FDA and FDB. In some example embodiments, the charge storing structure may be implemented with the transistor TS including the storage gate SG alone. In some example embodiments, the charge storing structure may be implemented with the storage gate SG and a storage diode formed in the semiconductor substrate under the storage gate SG. Using such a charge storing structure, true correlated double sampling (CDS) may be performed and noise in the readout signals may be reduced.

The charge stored in the floating diffusion regions FDA and FDB may be provided as output signal, e.g., the sampled data SOA and SOB using the source follower transistors TSF and the selection transistors TSL.

Referring to FIGS. 4, 7 and 8, the light source 210 may generate the transmission light TL modulated by a modulation frequency during an integration period TINT to collect a photo charge generated from an incident light. The row scanning circuit 130 may apply the first and second photogate signals (e.g., the first and second demodulation signals SPGA and SPGB), which have different phases, to the first and second photogates PGA and PGB corresponding to the first and second taps TA and TB.

The overflow voltage VOG applied to the overflow gates OG may have a turn-off voltage level VOFF to block the photo charge from being drained from the photodiode PD during the integration period TINT. The first and second demodulation transfer control signals STGA and STGB and the storage control signal SSG are activated during the integration period TINT. Accordingly, the photo charge collected by the first and second demodulation signals SPGA and SPGB may be stored in the semiconductor substrate under the storage gates SG, respectively.

During the other periods, for example, a reset period TRST to initialize the depth pixel PX1 and a readout period TRD to measure an amount of the photo charge collected during the integration period TINT, the overflow gate voltage VOG may have a turn-on voltage level VON to drain the photo charge from the photodiode PD. The collected photo charge may be drained to the terminal of the power supply voltage VDD during the periods TRST and TRD other than the integration period TINT. As such, a global shutter function may be implemented using the overflow gate OG.

At a first time point t0 during the readout period TRD when the reset signal SRG and the FD transfer control signal STG are deactivated and the selection signal SEL and the storage control signal SSG are activated, first and second reset state data of the first and second taps TA and TB may be output through the column lines, respectively. After the first time point t0 during the readout period TRD, when the reset signal SRG is activated and the storage control signal SSG is deactivated, the photo charge stored in the storage diode SD may be transferred to the floating diffusion regions FDA and FDB. At a second time point t1 during the readout period TRD when the FD transfer control signal STG is deactivated again and the storage control signal SSG is activated again, the photo charge stored in the floating diffusion regions FDA and FDB by transferring from the storage diode SD may be output through the column lines, respectively, as the first and second sampled data SOA and SOB of the first and second taps TA and TB.

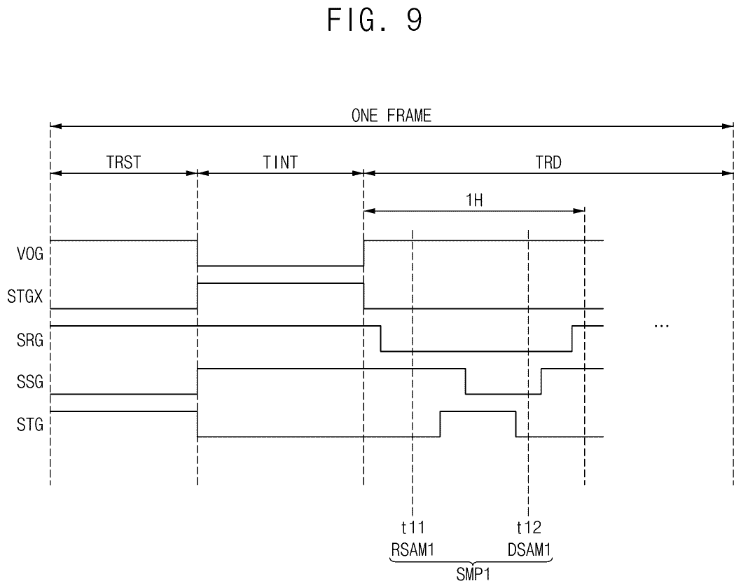

Referring now to FIGS. 9 through 38, example embodiments of sampling operations of a ToF sensor according to example embodiments will be described.

The timing diagrams in FIGS. 9, 13, 17, 20, 26, and 32 illustrate transition timings of an overflow gate voltage VOG, a demodulation transfer control signal STGX, a reset signal SRG, a storage gate control signal SSG, and an FD transfer control signal STG with respect to a reset period TRST, an intensity period TINT, and a readout period TRD included in one frame. The unit readout cycle 1H corresponds to a period during which the sampling operation is performed for one row, and the sampling operation may be performed repeatedly for a plurality of rows of the pixel array in a rolling scheme. The timing diagrams of FIGS. 9, 13, 17, 20, 26, and 32 illustrate example embodiments in which the photogate signal SPG corresponds to a demodulation signal.

In the timing diagrams of FIGS. 9, 13, 17, 20, 26, and 32, the signals (or voltages) VOG, STGX, SRG, SSG, and STG applied to the gates OG, TGX, RG, SG, and TG, respectively, may turn on the corresponding gate when the gate is activated to a logic high level, i.e., when the turn-on voltage is applied, and turn off the corresponding gate when the gate is deactivated to a logic low level, i.e., when the turn-off voltage is applied. The turn-on voltages of the gates OG, TGX, RG, SG, and TG may be the same or different. Similarly, the turn-off voltages of the gates OG, TGX, RG, SG, and TG may be the same or different.

In FIGS. 8, 9, 10, 11, 12, 14, 15, 16, 18, 19, 21, 22, 23, 24, 26, 27, 28, 29, 30, 31, 33, 34, 35, 36, 37, and 38, the voltages applied to the gates OG, TGX, RG, SG and TG at each time point and the corresponding potential profiles are shown. The drawings show potentials for electrons with negative charge, with lower heights in the drawings indicating higher potentials. In other words, when a turn-on voltage is applied to each gate, the potential may be high, and when a turn-off voltage is applied, the potential may be low. The hatched areas represent the charge of the collected or stored electrons. The turn-on voltages VON, VONX, VONR, VONS and VONT and the turn-off voltages VOFF, VOFFX, VOFFR, VOFFS and VOFFT applied to the gates OG, TGX, RG, SG and TG, respectively, and the DC voltage level VDC applied to the photogate PG may be set to appropriate levels according to the sampling sequence of the corresponding sampling operation.

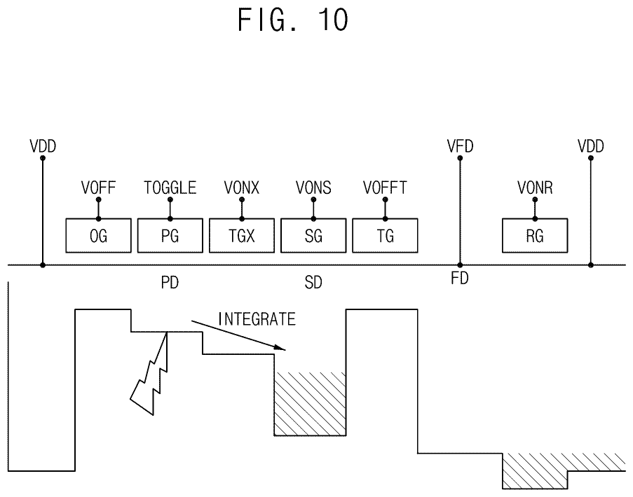

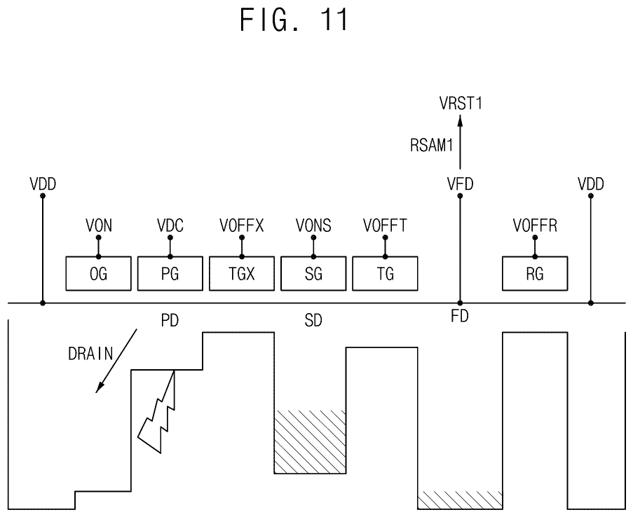

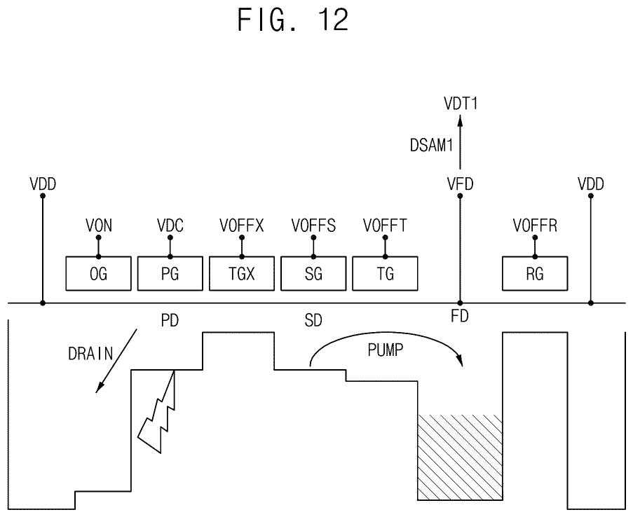

FIG. 9 is a timing diagram illustrating a first sampling operation of a ToF sensor according to example embodiments, and FIGS. 10 through 12 are diagrams illustrating applied voltages and potential profile according to the first sampling operation of FIG. 9 according to example embodiments. FIG. 10 illustrates a state of the integration period TINT, FIG. 11 illustrates a state at a first time point t11, and FIG. 12 illustrates a state at a second time point t12.

Referring to FIG. 9, during the reset period TRST, the overflow gate voltage VOG, the reset signal SRG, and the FD transfer control signal STG may be activated and the demodulation transfer control signal STGX and the storage gate control signal SSG may be deactivated to initialize the depth pixels.

During the integration period TINT, during which the photogate signal SPG corresponding to the demodulation signal is toggled, the overflow gate voltage VOG and FD transfer control signal STG are deactivated, and the demodulation transfer control signal STGX, the reset signal SRG, and the storage gate control signal SSG are activated such that photo charge may be collected in a charge storage structure (e.g., the storage diode SD of FIG. 2) blow the storage gate SG, as shown in FIG. 10.

During the readout period TRD, the overflow gate voltage VOG may be activated and the demodulation transfer control signal STGX may be deactivated, allowing the charge collected in the photodiode PD to drain to the voltage junction VJ1 in FIG. 2.

As shown in FIG. 9, during the unit readout cycle 1H, the first sampling operation SMP1 may be performed by controlling the transition timing of the reset signal SRG, the storage gate control signal SSG, and the FD transfer control signal STG. The first sampling operation SMP1 may include a first data sampling operation DSAM1 and a first reset sampling operation RSAM1 corresponding to the first data sampling operation DSAM1. As shown in FIG. 9, the first reset sampling operation RSAM1 may be performed before performing the first data sampling operation DSAM1.

After entering the unit readout cycle 1H, the reset signal SRG may be deactivated, the storage gate control signal SSG may remain activated, and the FD transfer control signal STG may remain deactivated. In other words, as shown in FIG. 11, at the first time point t11, a turn-on voltage VONS may be applied to the storage gate SG, a turn-off voltage VOFFT may be applied to the second transfer gate TG, and a turn-off voltage VOFFR may be applied to the reset gate RG. As a result, at the first time point t11, the voltage across the floating diffusion region FD corresponds to a reset level and a first reset sampling operation RSAM1 may be performed to sense the first reset voltage VRST1.

After the first reset sampling operation RSAM1 is performed, the FD transfer control signal STG may be activated and the storage control signal SSG may be deactivated. For example, the photo charge stored in the storage diode SD may be transferred to the floating diffusion region FD by activating the FD transfer control signal STG and deactivating the storage control signal SSG. Then, the FD transfer control signal STG may be deactivated again and the storage control signal SSG may be activated again. For example, as shown in FIG. 12, at a second time point t12, a turn-off voltage VOFFS may be applied to the storage gate SG, a turn-off voltage VOFFT may be applied to the second transfer gate TG, and a turn-off voltage VOFFR may be applied to the reset gate RG. The floating diffusion region FD may store the photo charge transferred from the storage diode SD. As a result, at the second time point t12, the voltage VFD in the floating diffusion region FD corresponds to a signal level and a first data sampling operation DSAM1 may be performed to sense a first signal voltage VDT1.

In this way, the first sampling operation SMP1 by the first conversion gain may be performed efficiently by performing the first reset sampling operation RSAM1 before performing the first data sampling operation DSAM1.

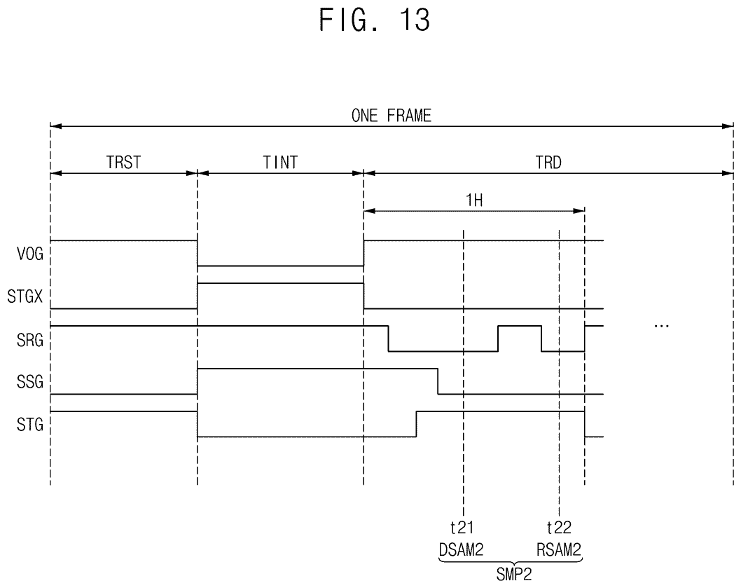

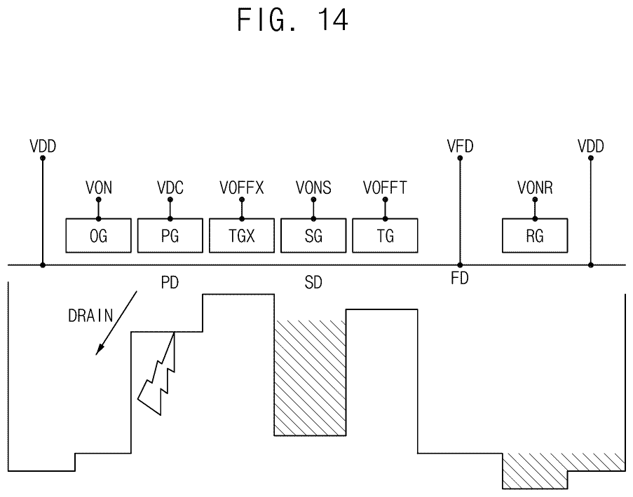

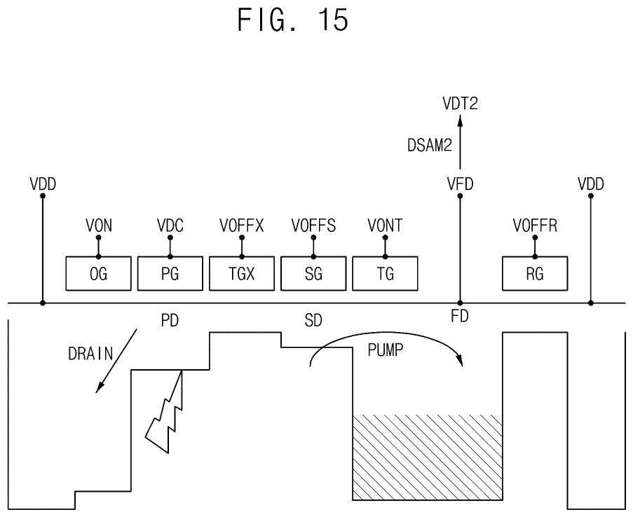

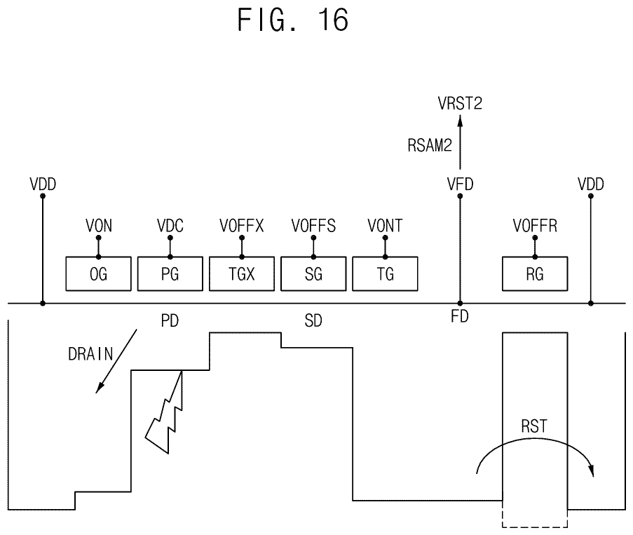

FIG. 13 is a timing diagram illustrating a second sampling operation of a ToF sensor according to example embodiments, and FIGS. 14 through 16 are diagrams illustrating applied voltages and potential profile according to the second sampling operation of FIG. 13 according to example embodiments. FIG. 14 shows a state immediately after the end of the integration period TINT, FIG. 15 shows a state at a first time point t21, and FIG. 16 shows a state at a second time point t22.

During the reset period TRST, the overflow gate voltage VOG, the reset signal SRG, and the FD transfer control signal STG are activated, and the demodulation transfer control signal STGX and the storage gate control signal SSG are deactivated such that the depth pixels may be initialized.

During the integration period TINT, during which the photogate signal SPG corresponding to the demodulation signal is toggled, the overflow gate voltage VOG and FD transfer control signal STG are deactivated, and the demodulation transfer control signal STGX, reset signal SRG, and storage gate control signal SSG are activated such that photo charge may be collected in a charge storage structure (e.g., the storage diode SD of FIG. 2) below the storage gate SG, as shown in FIG. 10.

During the readout period TRD, the overflow gate voltage VOG is activated and the demodulation transfer control signal STGX is deactivated such that the charge collected in the photodiode PD may be drained to the voltage junction VJ1 in FIG. 2.

As shown in FIG. 13, during the unit readout cycle 1H, a second sampling operation SMP2 may be performed by controlling the transition timing of the reset signal SRG, the storage gate control signal SSG, and the FD transfer control signal STG. The second sampling operation SMP2 may include a second data sampling operation DSAM2 and a second reset sampling operation RSAM2 corresponding to the second data sampling operation DSAM2. As shown in FIG. 13, the second reset sampling operation RSAM2 may be performed after the second data sampling operation DSAM2 is performed.

After entering the unit readout cycle 1H, the reset signal SRG may be deactivated, the FD transfer control signal STG may be activated, and the storage gate control signal SSG may be deactivated. For example, as shown in FIG. 15, at the first time point t21, the storage gate SG may be applied a turn-off voltage VOFFS, the second transfer gate TG may be applied a turn-on voltage VONT, and the reset gate RG may be applied a turn-off voltage VOFFR. As a result, at the first time point t21, the voltage VFD across the floating diffusion region FD corresponds to a signal level and a second data sampling operation DSAM2 may be performed to sense a second signal voltage VDT2. Compared to the first data sampling operation DSAM1 of FIG. 12, which is performed with a first conversion gain, the second data sampling operation DSAM2 of FIG. 15 may be performed with a second conversion gain that is smaller than the first conversion gain because the second transfer gate TG is in the turned-on state.

After the second data sampling operation DSAM2 is performed, the reset signal SRG may be toggled to reset (RST) the voltage VFD of the floating diffusion region FD as shown in FIG. 16. As a result, at the second time point t22, the voltage of the floating diffusion region FD corresponds to a reset level and a second reset sampling operation RSAM2 may be performed to sense the second reset voltage VRST2.

In this way, by performing the second data sampling operation DSAM2 before performing the second reset sampling operation RSAM2, the second sampling operation SMP2 by the second conversion gain may be performed efficiently.

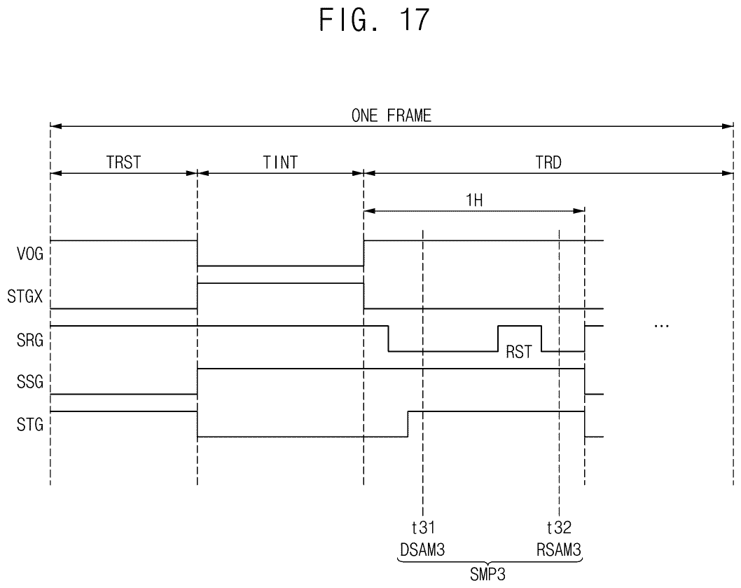

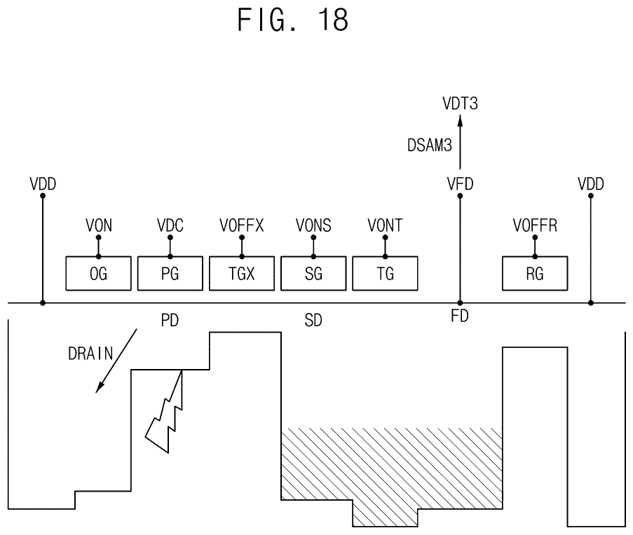

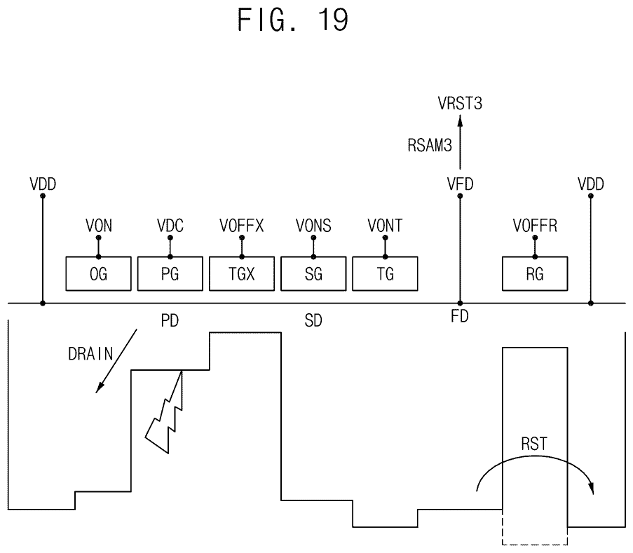

FIG. 17 is a timing diagram illustrating a third sampling operation of a ToF sensor according to example embodiments, and FIGS. 18 and 19 are diagrams illustrating applied voltages and a potential profile according to the third sampling operation of FIG. 17 according to example embodiments. FIG. 18 illustrates a state at a first time point t31, and FIG. 19 illustrates a state at a second time point t32.

During the reset period TRST, the overflow gate voltage VOG, reset signal SRG, and FD transfer control signal STG are activated and the demodulation transfer control signal STGX and the storage gate control signal SSG are deactivated such that the depth pixels may be initialized.

During the integration period TINT, during which the photogate signal SPG corresponding to the demodulation signal is toggled, the overflow gate voltage VOG and the FD transfer control signal STG are deactivated, and the demodulation transfer control signal STGX, the reset signal SRG, and the storage gate control signal SSG are activated such that photo charge may be collected in a charge storage structure (e.g., the storage diode SD in FIG. 2) below the storage gate SG, as shown in FIG. 10.

During the readout period TRD, the overflow gate voltage VOG may be activated and the demodulation transfer control signal STGX may be deactivated, allowing the charge collected in the photodiode PD to drain to the voltage junction VJ1 in FIG. 2.

As shown in FIG. 17, during the unit readout cycle 1H, a third sampling operation SMP3 may be performed by controlling the transition timing of the reset signal SRG, the storage gate control signal SSG, and the FD transfer control signal STG. The third sampling operation SMP3 may include a third data sampling operation DSAM3 and a third reset sampling operation RSAM3 corresponding to the third data sampling operation DSAM3. As shown in FIG. 17, the third reset sampling operation RSAM3 may be performed after performing the third data sampling operation DSAM3.

After entering the unit readout cycle 1H, the reset signal SRG may be deactivated, the FD transfer control signal STG may be activated, and the storage gate control signal SSG may remain activated. In other words, as shown in FIG. 18, at the first time point t31, the storage gate SG may be applied with a turn-on voltage VONS, the second transfer gate TG may be applied with a turn-on voltage VONT, and the reset gate RG may be applied with a turn-off voltage VOFFR. As a result, at the first time point t31, the voltage across the floating diffusion region FD corresponds to a signal level and a third data sampling operation DSAM3 may be performed to sense a third signal voltage VDT3. Compared to the second data sampling operation DSAM2 of FIG. 15, which is performed with the second conversion gain, the third data sampling operation DSAM3 of FIG. 18 has a third conversion gain smaller than the second conversion gain because the second transfer gate TG as well as the storage gate SG are in the turned-on state.

After the third data sampling operation DSAM3 is performed, the reset signal SRG may toggle to reset (RST) the voltage of the floating diffusion region FD as shown in FIG. 19. As a result, at the third time point t32, the voltage of the floating diffusion region FD corresponds to the reset level and the third reset sampling operation RSAM3 may be performed to sense the third reset voltage VRST3.

In this way, by performing the third reset sampling operation RSAM3 after performing the third data sampling operation DSAM3, the third sampling operation SMP3 by the third conversion gain may be performed efficiently.

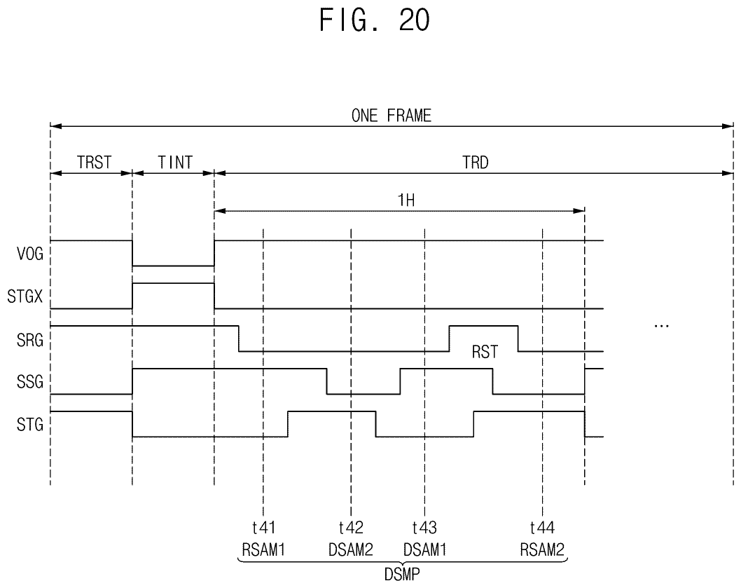

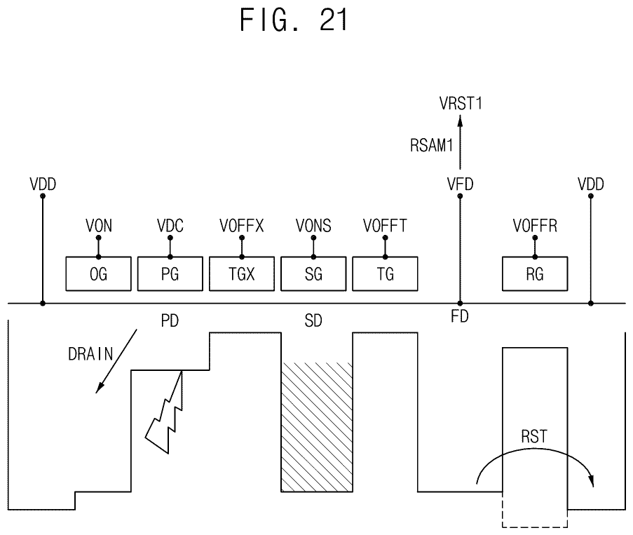

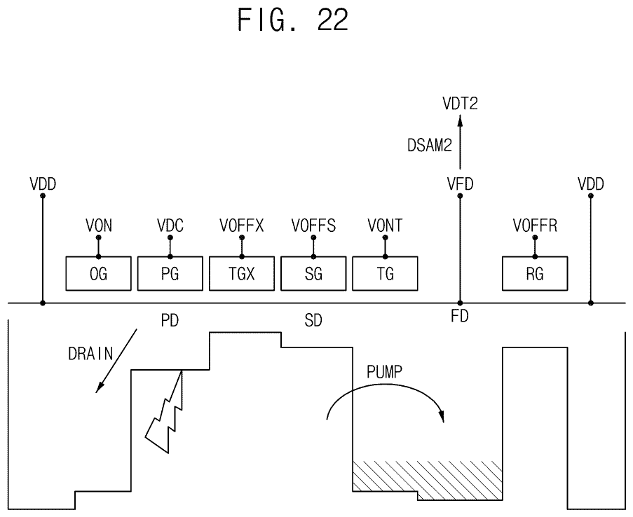

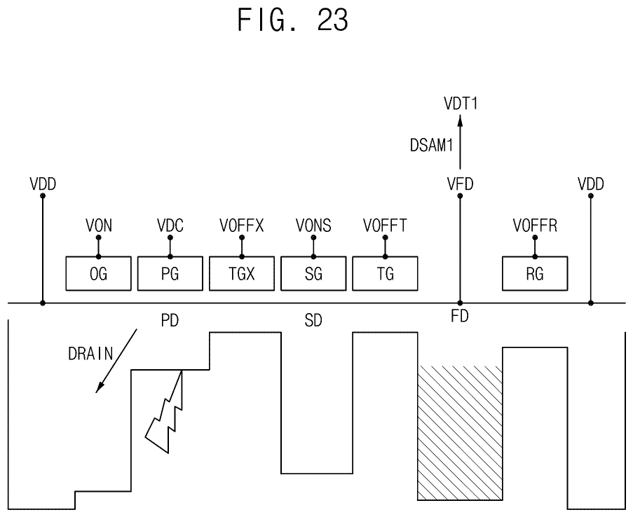

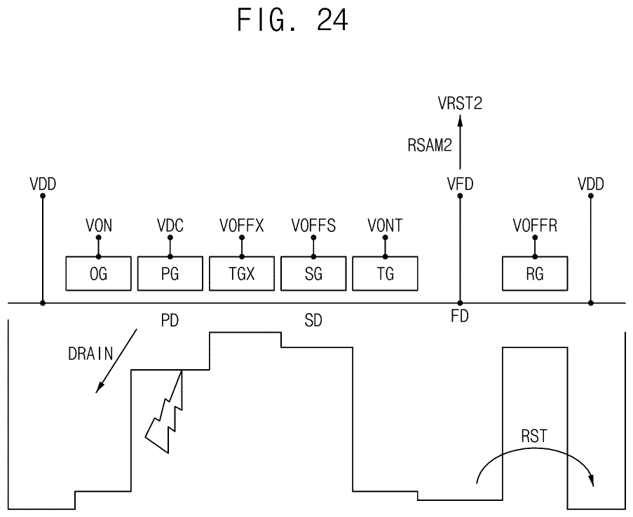

FIG. 20 is a timing diagram illustrating a double sampling operation of a ToF sensor according to example embodiments, and FIGS. 21 to 24 are diagrams illustrating applied voltages and a potential profile according to the double sampling operation of FIG. 20 according to example embodiments. FIG. 21 illustrates a state at a first time point t41, FIG. 22 illustrates a state at a second time point t42, FIG. 23 illustrates a state at a third time point t43, and FIG. 24 illustrates a state at a fourth time point t44.

Hereinafter, an operation sequence of the double sampling operation DSMP will be described, omitting the description that is redundant with the first sampling operation SMP1 and the second sampling operation SMP2 as described above with reference to FIGS. 9 to 16.

As shown in FIG. 20, during the unit readout cycle 1H, the double sampling operation DSMP may be performed by controlling the transition timing of the reset signal SRG, the storage gate control signal SSG, and the FD transfer control signal STG. The double sampling operation DSMP may include a first data sampling operation DSAM1, a second data sampling operation DSAM2, a first reset sampling operation RSAM1 corresponding to the first data sampling operation DSAM1, and a second reset sampling operation RSAM2 corresponding to the second data sampling operation DSAM2.

Referring to FIG. 20, the double sampling operation DSMP may be performed in which the first data sampling operation DSAM1 is performed after the second data sampling operation DSAM2 is performed, during one unit read cycle 1H with respect to one tap. As illustrated in FIG. 20, after performing the second data sampling operation DSAM2 at the second time point t42, the first data sampling operation DSAM1 may be performed at the third time point t43.

Further, during the one unit readout cycle 1H with respect to the one tap, the first reset sampling operation RSAM1 corresponding to the first data sampling operation DSAM1 may be performed before performing the second data sampling operation DSAM2. As illustrated in FIG. 20, before performing the second data sampling operation DSAM2 at the second time point t42, the first reset sampling operation RSAM1 corresponding to the first data sampling operation DSAM1 at the first time point t41 may be performed.

Further, during the one unit readout cycle 1H with respect to the one tap, the second reset sampling operation RSAM2 corresponding to the second data sampling operation DSAM2 may be performed after performing the first data sampling operation DSAM1. As illustrated in FIG. 20, after performing the first data sampling operation DSAM1 at the third time point t43, the second reset sampling operation RSAM2 corresponding to the second data sampling operation DSAM2 may be performed at the fourth time point t44.

In this way, by performing the first reset sampling operation RSAM1, the second data sampling operation DSAM2, the first data sampling operation DSAM1, and the second reset sampling operation RSAM2 sequentially, the first sampling operation SMP1 by the first conversion gain and the second sampling operation SMP2 by the second conversion gain may be efficiently performed during the same unit reading cycle 1H with respect to the same tap.

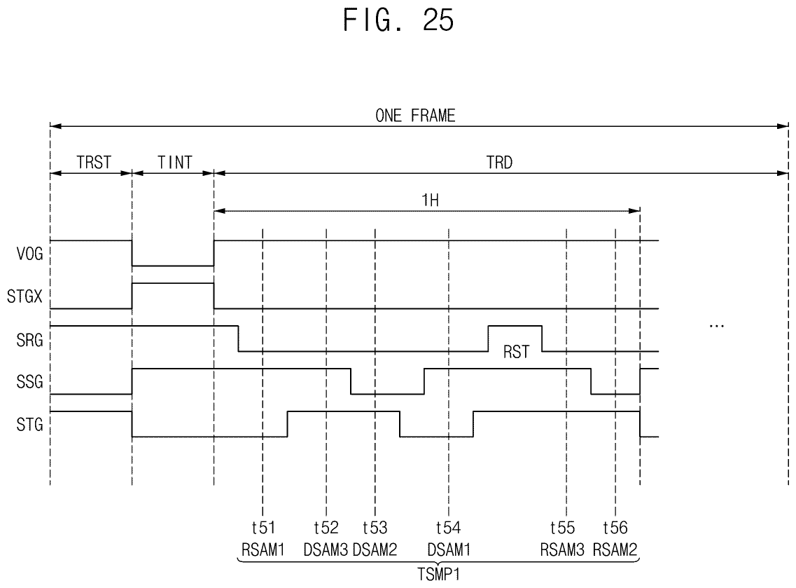

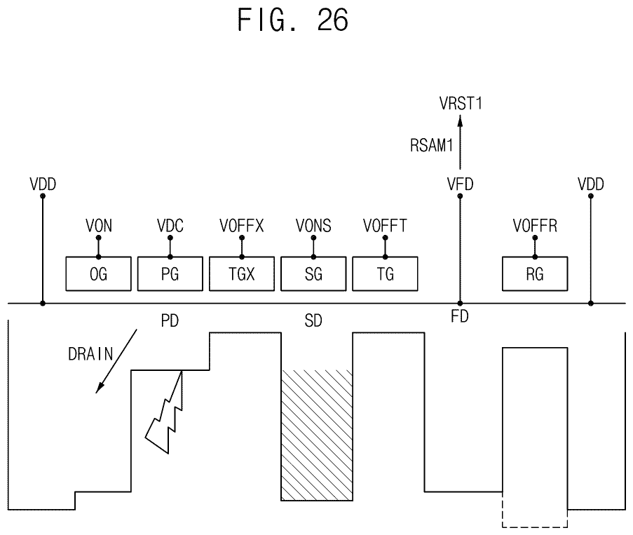

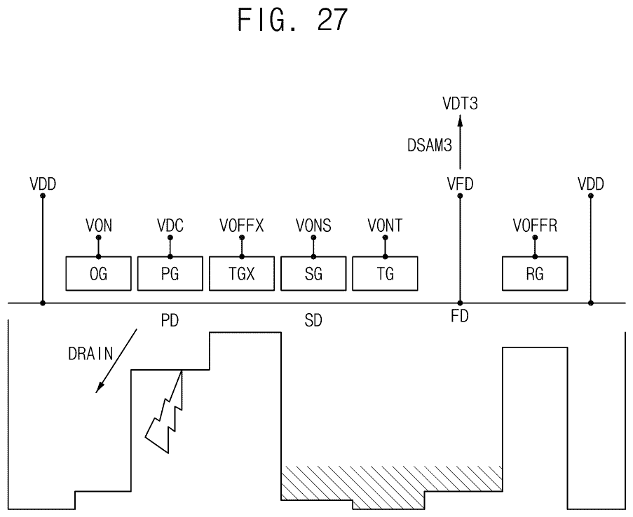

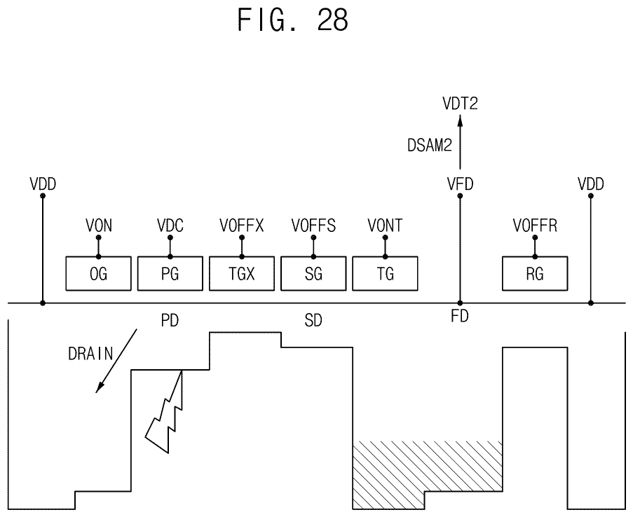

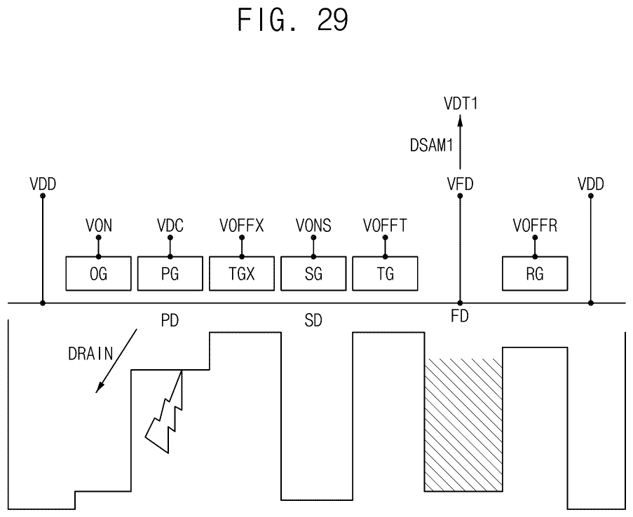

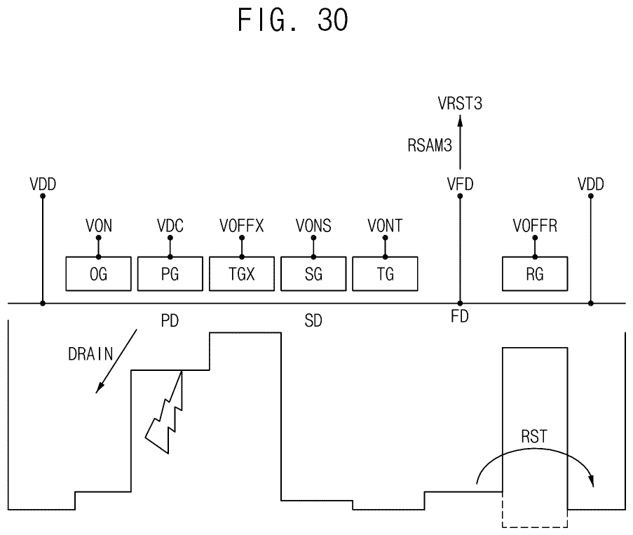

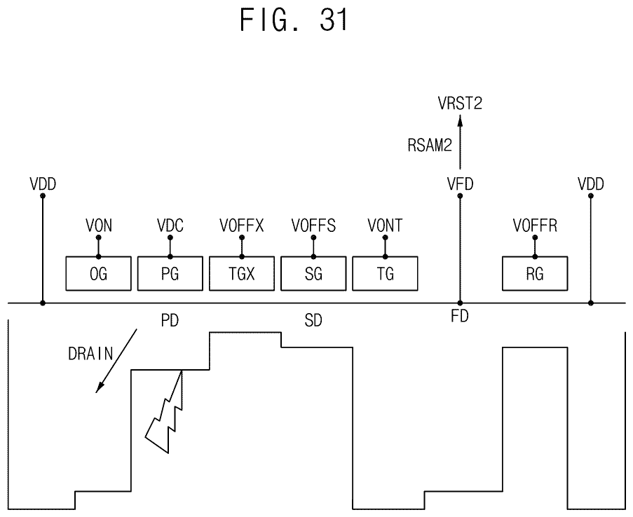

FIG. 25 is a timing diagram illustrating a triple sampling operation of a ToF sensor according to example embodiments, an FIGS. 26 to 31 are diagrams illustrating applied voltages and a potential profile according to the triple sampling operation of FIG. 25 according to example embodiments. FIG. 26 illustrates a state at a first time point t51, FIG. 27 illustrates a state at a second time point t52, FIG. 28 illustrates a state at a third time point t53, FIG. 29 illustrates a state at a fourth time point t54, FIG. 30 illustrates a state at a fifth time point t55, and FIG. 31 illustrates a state at a sixth time point t56.

Hereinafter, an operation sequence of a triple sampling operation TSMP1 will be described, omitting the description that is redundant with the first sampling operation SMP1, the second sampling operation SMP2, and the third sampling operation SMP3 as described above with reference to FIGS. 9 to 19.

As shown in FIG. 25, during the unit readout cycle 1H, the triple sampling operation TSMP1 may be performed by controlling the transition timing of the reset signal SRG, the storage gate control signal SSG, and the FD transfer control signal STG. The triple sampling operation TSMP1 includes a first data sampling operation DSAM1, a second data sampling operation DSAM2, a third data sampling operation DSAM3, and a first reset sampling operation RSAM1 corresponding to the first data sampling operation DSAM1, a second reset sampling operation RSAM2 corresponding to the second data sampling operation DSAM2, and a third reset sampling operation RSAM3 corresponding to the third data sampling operation DSAM3.

Referring to FIG. 25, the triple sampling operation TSMP1 may be performed during one unit readout cycle 1H with respect to one tap, in which the third data sampling operation DSAM3 is performed before the second data sampling operation DSAM2, and the first data sampling operation DSAM1 is performed after the second data sampling operation DSAM2. As illustrated in FIG. 25, the third data sampling operation DSAM3 may be performed at the second time point t52, the second data sampling operation DSAM2 may be performed at the third time point t53, and the first data sampling operation DSAM1 may be performed at the fourth time point t54.

Further, during one unit readout cycle 1H with respect to the one tap, the first reset sampling operation RSAM1 corresponding to the first data sampling operation DSAM1 may be performed before performing the third data sampling operation DSAM3. As shown in FIG. 25, the first reset sampling operation RSAM1 may be performed at the first time point t51 before performing the third data sampling operation DSAM3 at the second time point t52.

Further, during the one unit readout cycle 1H with respect to the one tap, the third reset sampling operation RSAM3 corresponding to the third data sampling operation DSAM3 may be performed after performing the first data sampling operation DSAM1. As illustrated in FIG. 25, after performing the first data sampling operation DSAM1 at the fourth time point t54, the third reset sampling operation RSAM3 may be performed at the fifth time point t55.

Further, during the one unit readout cycle 1H with respect to the one tap, after performing the third reset sampling operation RSAM3, the second reset sampling operation RSAM2 corresponding to the second data sampling operation DSAM2 may be performed. As illustrated in FIG. 25, after performing the third reset sampling operation RSAM3 at the fifth time point t55, the second reset sampling operation RSAM2 may be performed at the sixth time point t56.

In this way, by performing the first reset sampling operation RSAM1, the third data sampling operation DSAM3, the second data sampling operation DSAM2, the first data sampling operation DSAM1, the third reset sampling operation RSAM3, and the second reset sampling operation RSAM2 sequentially, the first sampling operation SMP1 with the first conversion gain, the second sampling operation SMP2 with the second conversion gain, and the third sampling operation SMP3 with the third conversion gain may be efficiently performed during the same unit readout cycle 1H with respect to the same tap.

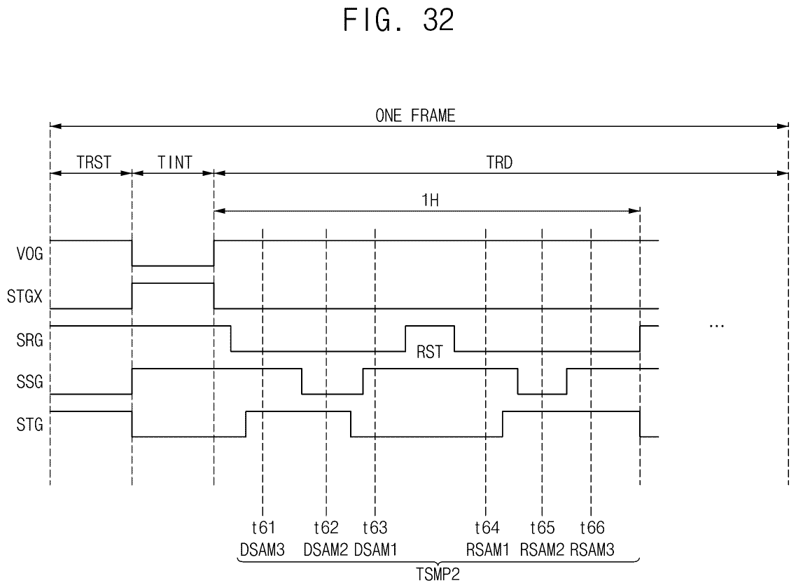

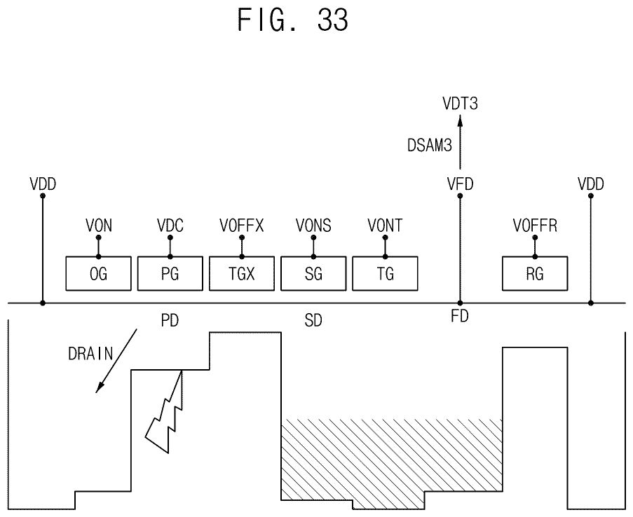

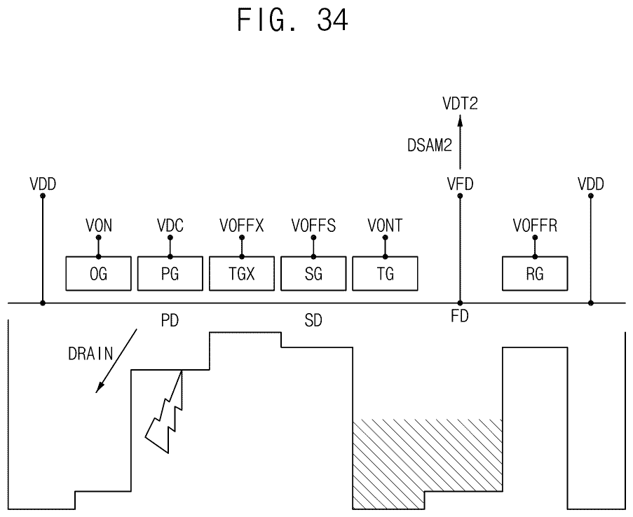

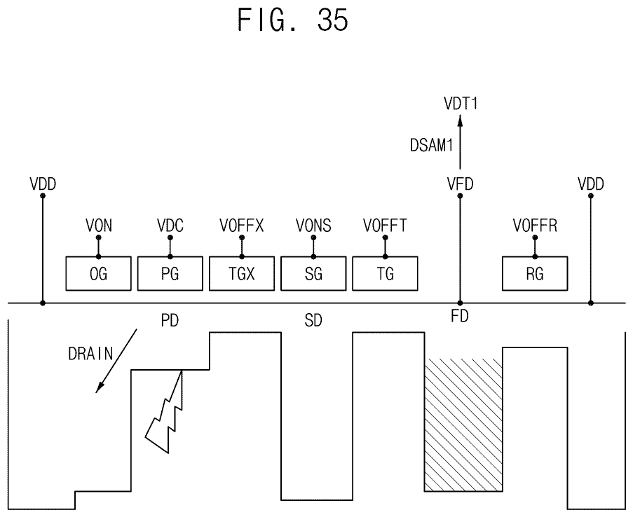

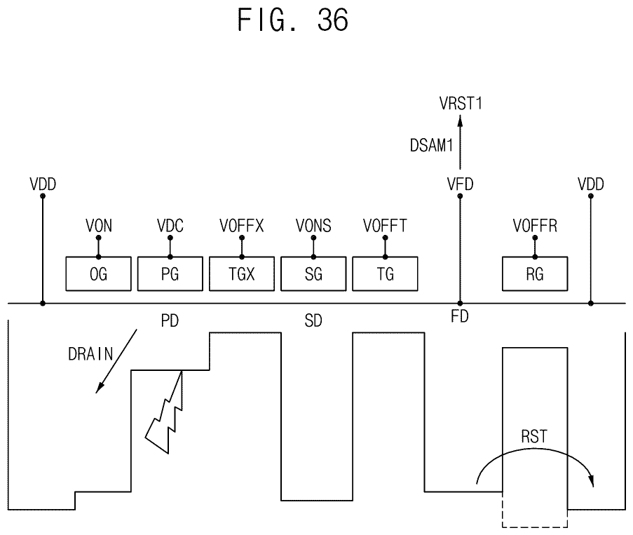

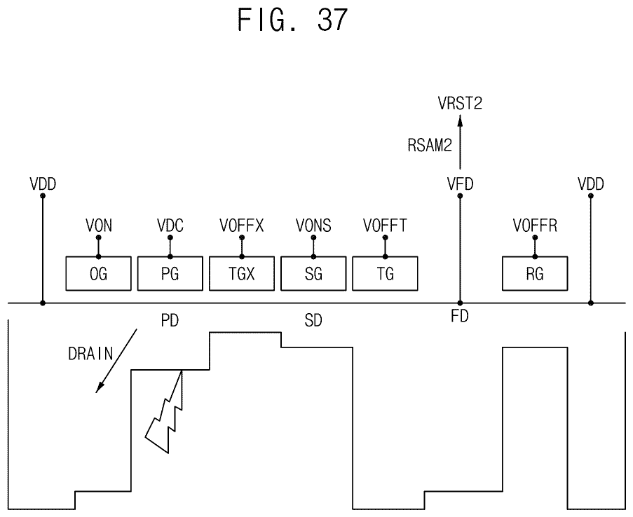

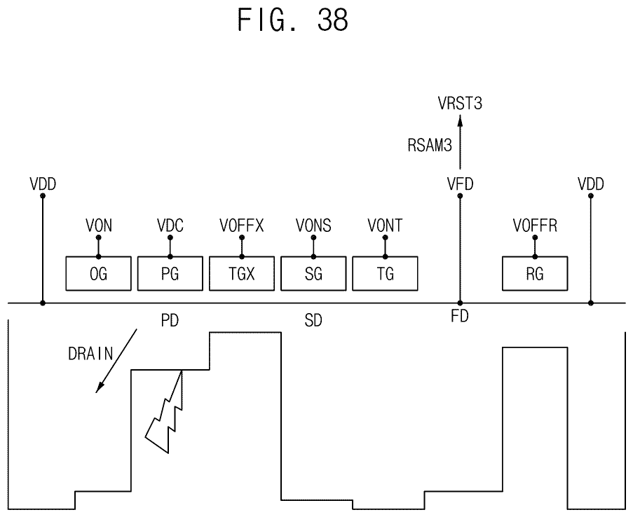

FIG. 32 is a timing diagram illustrating a triple sampling operation of a ToF sensor according to example embodiments, and FIGS. 33 and 38 are diagrams illustrating applied voltages and a potential profile according to the triple sampling operation of FIG. 32 according to example embodiments. FIG. 33 illustrates a state at a first time point t61, FIG. 34 illustrates a state at a second time point t62, FIG. 35 illustrates a state at a third time point t63, FIG. 36 illustrates a state at a fourth time point t64, FIG. 37 illustrates a state at a fifth time point t65, and FIG. 38 illustrates a state at a sixth time point t66.

Hereinafter, an operation sequence of a triple sampling operation TSMP2 will be described, omitting the description that is redundant with the first sampling operation SMP1, the second sampling operation SMP2, and the third sampling operation SMP3 as described above with reference to FIGS. 9 to 19.

As shown in FIG. 32, during the unit readout cycle 1H, the triple sampling operation TSMP2 may be performed by controlling the transition timing of the reset signal SRG, the storage gate control signal SSG, and the FD transfer control signal STG. The triple sampling operation TSMP2 includes a first data sampling operation DSAM1, a second data sampling operation DSAM2, a third data sampling operation DSAM3, and a first reset sampling operation RSAM1 corresponding to the first data sampling operation DSAM1, a second reset sampling operation RSAM2 corresponding to the second data sampling operation DSAM2, and a third reset sampling operation RSAM3 corresponding to the third data sampling operation DSAM3.

Referring to FIG. 32, the triple sampling operation TSMP2 may be performed during one unit readout cycle 1H with respect to one tap, wherein the third data sampling operation DSAM3 is performed before the second data sampling operation DSAM2, and the first data sampling operation DSAM1 is performed after the second data sampling operation DSAM2. As illustrated in FIG. 32, the third data sampling operation DSAM3 may be performed at the first time point t61, the second data sampling operation DSAM2 may be performed at the second time point t62, and the first data sampling operation DSAM1 may be performed at the third time point t63.

Further, during the one unit readout cycle 1H with respect to the one tap, after performing the first data sampling operation DSAM1, the first reset sampling operation RSAM1 corresponding to the first data sampling operation DSAM1 may be performed. As shown in FIG. 32, after performing the first data sampling operation DSAM1 at the third time point t63, the first reset sampling operation RSAM1 may be performed at the fourth time point t64.

Further, with respect to the one tab, during the one unit readout cycle 1H, after performing the first reset sampling operation RSAM1, the second reset sampling operation RSAM2 corresponding to the second data sampling operation DSAM2 may be performed. As illustrated in FIG. 32, after performing the first reset sampling operation RSAM1 at the fourth time point t64, the second reset sampling operation RSAM2 may be performed at the fifth time point t65.

Further, with respect to the one tab, during the one unit readout cycle 1H, after performing the second reset sampling operation RSAM2, the third reset sampling operation RSAM3 corresponding to the third data sampling operation DSAM3 may be performed. As illustrated in FIG. 32, after performing the second reset sampling operation RSAM2 at the fifth time point t65, the third reset sampling operation RSAM3 may be performed at the sixth time point t66.

In this way, by sequentially performing the third data sampling operation DSAM3, the second data sampling operation DSAM2, the first data sampling operation DSAM1, the first reset sampling operation RSAM1, the second reset sampling operation RSAM2, and the third reset sampling operation RSAM3, the first sampling operation SMP1 by the first conversion gain, the second sampling operation SMP2 by the second conversion gain, and the third sampling operation SMP3 by the third conversion gain may be efficiently performed with respect to the same tap during the one unit readout cycle 1H.

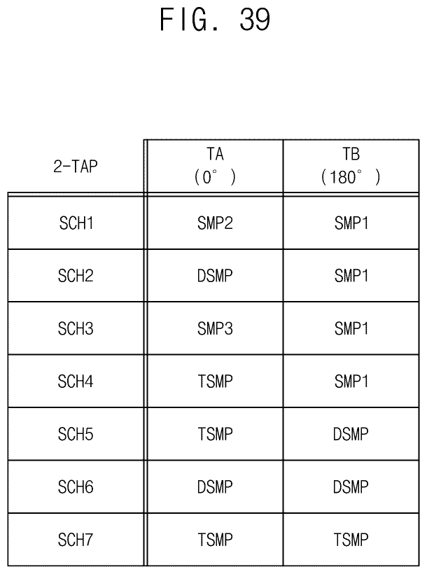

FIG. 39 is a diagram illustrating sampling operations applicable to a depth pixel having a two-tap structure included in a ToF sensor according to example embodiments.

FIG. 39 illustrates first to seventh schemes SCH1 to SCH7 corresponding to example combinations of sampling operations, but the present invention is not limited thereto.

As described above with reference to FIGS. 7 and 8, the depth pixel may have a two-tap structure in which a first tap TA that operates based on a first demodulation signal SPGA or a first demodulation transfer control signal STGA having a phase difference of 0 degrees from the transmission light TL and a second tap TB that operates based on a second demodulation signal SPGB or a second demodulation transfer control signal STGB having a phase difference of 180 degrees from the transmission light TL are connected to one photodiode PD.

FIG. 39 illustrates various combinations of the first sampling operation SMP1, the second sampling operation SMP2, the third sampling operation SMP3, the double sampling operation DSMP, and the triple sampling operation TSMP that are applied to the first tap TA and the second tap TB, respectively, during the unit readout cycle 1H of FIGS. 9 to 38. In this case, the triple sampling operation TSMP may be one of the triple sampling operation TSMP1 and the triple sampling operation TSMP2. The first sampling operation SMP1 is described with reference to FIGS. 9 to 12, the second sampling operation SMP2 is described with reference to FIGS. 13 to 16, the third sampling operation SMP3 is described with reference to FIGS. 17 to 19, the double sampling operation DSMP is described with reference to FIGS. 20 to 24, the triple sampling operation TSMP1 is described with reference to FIGS. 25 to 31, and the triple sampling operation TSMP2 is described with reference to FIGS. 32 to 38; therefore, redundant descriptions are omitted.

For example, according to the first scheme SCH1, during a unit readout cycle 1H, the second sampling operation SMP2 may be performed with respect to the first tap TA and the first sampling operation SMP1 may be performed with respect to the second tap TB. As described above, when applying correlated double sampling (CDS), the first sampling operation SMP1 may include the first data sampling operation DSAM1 and the first reset sampling operation RSAM1, and the second sampling operation SMP2 may include the second data sampling operation DSAM2 and the second reset sampling operation RSAM2.

For example, according to the second scheme SCH2, during a unit readout cycle 1H, the double sampling operation DSMP may be performed with respect to the first tap TA and the first sampling operation SMP1 may be performed with respect to the second tap TB. As described above, when applying correlated double sampling (CDS), the double sampling operation DSMP may include the first data sampling operation DSAM1, the first reset sampling operation RSAM1, the second data sampling operation DSAM2, and the second reset sampling operation RSAM2.

For example, according to the third scheme SCH3, during a unit readout cycle 1H, the third sampling operation SMP3 may be performed with respect to the first tap TA and the first sampling operation SMP1 may be performed with respect to the second tap TB.

For example, according to the fourth scheme SCH4, during the unit readout cycle 1H, the triple sampling operation TSMP may be performed with respect to the first tap TA and the first sampling operation SMP1 may be performed with respect to the second tap TB. As described above, when applying correlated double sampling (CDS), the triple sampling operation TSMP may include the first data sampling operation DSAM1, the first reset sampling operation RSAM1, the second data sampling operation DSAM2, the second reset sampling operation RSAM2, the third data sampling operation DSAM3, and the third reset sampling operation RSAM3.

Referring again to FIG. 4, the reception light RL reflected from the object OBJ and incident on the depth pixel of the ToF sensor 100 is roughly inversely proportional to the square of the distance between the depth pixel and the object OBJ. Accordingly, when the object OBJ approaches the ToF sensor 100, the first tap TA senses relatively high-intensity reception light RL and the second tap TB senses relatively low-intensity reception light RL. Therefore, as the first to fifth schemes SCH1 to SCH5, a sampling operation corresponding to a relatively small conversion gain may be applied to the first tap TA and a sampling operation corresponding to a relatively greater conversion gain may be applied to the second tap TB.

According to example embodiments, as the sixth and seventh methods SCH6 and SCH7, the same sampling operation may be applied to the first tap TA and the second tap TB.

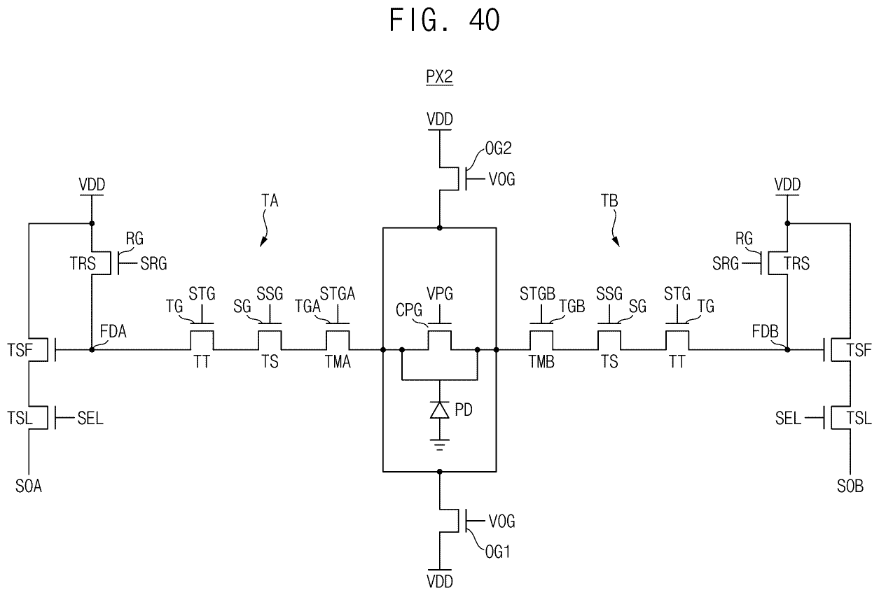

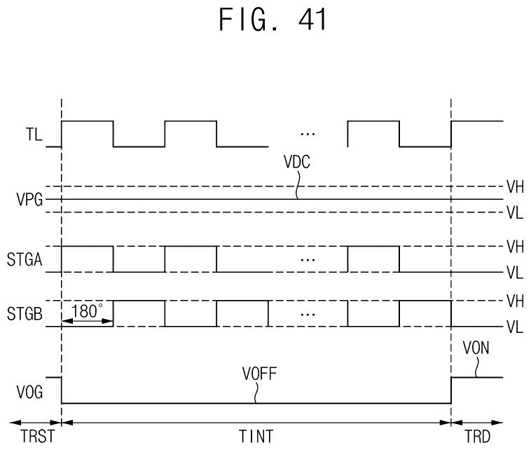

FIG. 40 is a circuit diagram illustrating a depth pixel having a two-tap structure included in a ToF sensor according to example embodiments, and FIG. 41 is a timing diagram illustrating an operation of the ToF sensor including the depth pixel of FIG. 40 according to example embodiments. A depth pixel PX2 of FIG. 40 is similar to the depth pixel PX1 of FIG. 7, and the descriptions repeated with FIGS. 7 and 8 may be omitted.

Referring to FIG. 40, the depth pixel PX2 includes a common photogate CPG instead of the first and second photogates PGA and PGB of the depth pixel PX1 of FIG. 7.

Referring to FIGS. 40 and 41, during an integration period TINT, a photogate voltage VPG applied to the common photogate CPG may have a DC voltage level VDC that causes collecting of the photo charge, and the overflow gate voltage VOG applied to the overflow gates OG1 and OG2 may have a turn-off voltage level VOFF that causes draining of the photo charge to be blocked. The DC voltage level VDC may be a voltage level between a high voltage level VH of the first and second demodulation transfer control signals STGA and STGB and a low voltage level VL of the first and second demodulation transfer control signals STGA and STGB.

In addition, during the integration period TINT, the first and second demodulation transfer control signals STGA and STGB of different phases may be applied to the first and second demodulation transfer gates TGA and TGB, respectively. The phase of the first demodulation transfer control signal STGA may be synchronized with the phase of the transmission light TL. In some example embodiments, the phase difference between the first and second demodulation transfer control signals STGA and STGB may be about 180 degrees.

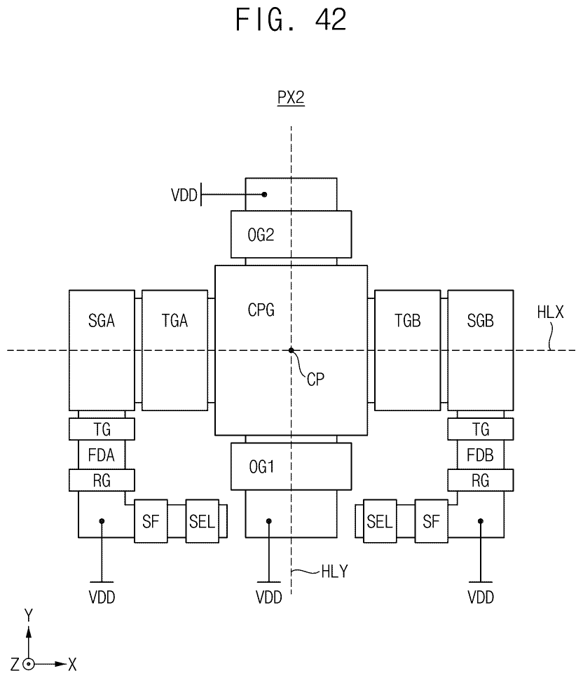

FIG. 42 is a diagram illustrating a layout of the depth pixel of FIG. 40 according to example embodiments. The description redundant with FIGS. 7, 8, 40, and 41 may be omitted.

Referring to FIG. 42, a depth pixel PX2 may include transistors TMA, TS and TT corresponding to a first tap TA, transistors TMB, TS and TT corresponding to a second tap TB, transistors TRS, TSF and TSL corresponding to a readout circuit, and a common photogate CPG, overflow gates OG1 and OG2, and a photodiode PD corresponding to a shared circuit.

Each of the transistors TMA, TMB, TS, TT and TRS may include a gate disposed on an upper portion of a semiconductor substrate, and a source region and a drain region formed on an upper portion of the semiconductor substrate on both sides of the gate. The gates of the transistors TMA, TMB, TS, TT and TRS correspond to the first demodulation transfer gate TGA, the second demodulation transfer gate TGB, the storage gate SG, the second transfer gate TG, and the reset gate RG, respectively.

A photogate voltage VPG is applied to the common photogate CPG, an overflow gate voltage VOG is applied to the overflow gates OG1 and OG2, a storage control signal SSG is applied to the storage gate SG, an FD transfer control signal STG is applied to the second transfer gate TG, a reset signal SRG is applied to the reset gate RG, and a selection signal SEL is applied to the gate of the selection transistor TSL. A first demodulation transfer control signal STGA and a second demodulation transfer control signal STGB, which have different phases, are applied to the first demodulation transfer gate TGA and the second demodulation transfer gate TGB, respectively.

The photogate voltage VPG, the overflow gate voltage VOG, the storage control signal SSG, the FD transfer control signal STG, the reset signal SRG, the selection signal SEL, and the first and second demodulation transfer control signals STGA and STGB may be provided from the row scan circuit 130 under control of the controller 150 of FIG. 4.

As shown in FIG. 42, one common photogate CPG is arranged in the center region, and the first and second demodulation transfer gates TGA and TGB and the overflow gates OG1 and OG2 have a symmetrical structure with respect to the common photogate CPG. The first and second demodulation transfer gates TGA and TGB are arranged symmetrically with respect to each of a first horizontal line HLX and a second horizontal line HLY that pass through a center CP of the depth pixel PX2 and are perpendicular to each other. For example, the first demodulation transfer gate TGA and the second demodulation transfer gate TGC are symmetrical with respect to the center of the depth pixel PX2. In addition, the overflow gates OG1 and OG2 are symmetrically arranged with respect to each of the first horizontal line HLX and the second horizontal line HLY Through this symmetrical structure, the characteristic deviation between multiple taps may be reduced and the sensing accuracy of the depth pixel may be improved.

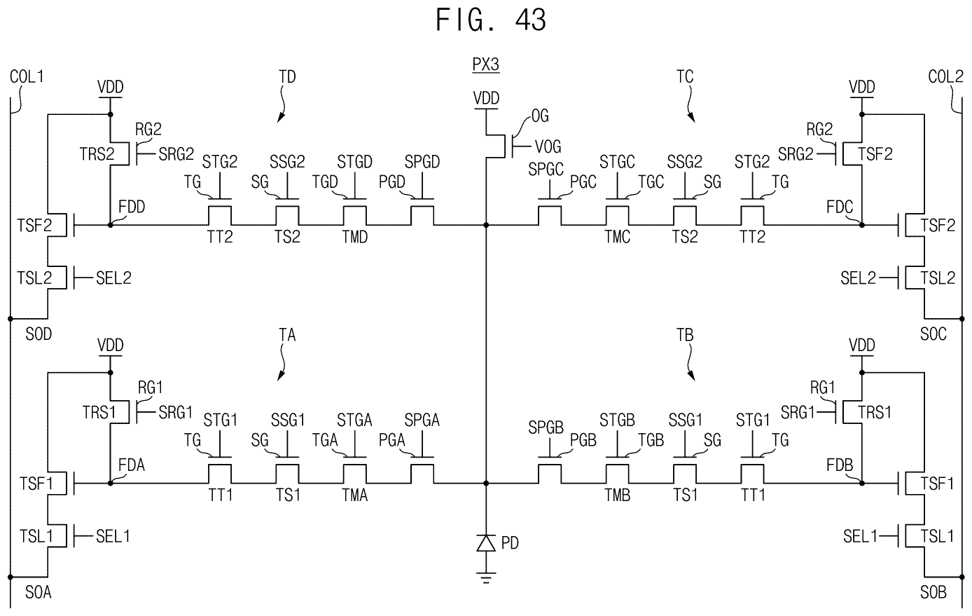

FIG. 43 is a circuit diagram illustrating a depth pixel having a four-tap structure included in a ToF sensor according to example embodiments. FIG. 43 illustrates a four-tap structure in which individual photogate is applied per tap. Hereinafter, the descriptions repeated with FIGS. 7 and 8 may be omitted.

Referring to FIG. 43, a depth pixel PX3 may include a first photogate PGA and transistors TMA, TS1 and TT1 corresponding to a first tap TA, a second photogate PGB and transistors TMB, TS1 and TT1 corresponding to a second tap TB, a third photogate PGC and transistors TMC, TS2 and TT2 corresponding to a third tap TC, a fourth photogate PGD and transistors TMD, TS2 and TT2 corresponding to a fourth tap TD, transistors TRS1, TRS2, TSF1, TSF2, TSL1 and TSL2 corresponding to a readout circuit, and an overflow gate OG and a photodiode corresponding to a shared circuit.

Each of the transistors TMA, TMB, TMC, TMD, TS1, TS2, TT1, TT2, TRS1 and TRS2 may include a gate disposed above a semiconductor substrate and source and drain regions disposed at respective sides of the gate in the semiconductor substrate. The gates of the transistors TMA, TMB, TMC, TMD, TS1, TS2, TT1, TT2 and TRS1 may correspond to a first demodulation transfer gate TGA, a second demodulation transfer gate TGB, a third demodulation transfer gate TGC, a fourth demodulation transfer gate TGD, storage gates SG, second transfer gates TG and reset gates RG1 and RG2, respectively.

First through fourth photogate signals SPGA through SPGD are applied to the first through fourth photogates PGA through PGD, an overflow gate voltage VOG is applied to the overflow gates OG, storage control signals SSG1 and SSG2 are applied to the storage gates SG1 and SG2, demodulation transfer control signals STGA through STGD are applied to the demodulation transfer gates TGA through TGD, FD transfer control signals STG1 and STG2 are applied to the second transfer gates TG1 and TG2, reset signals SRG1 and SRG2 are applied to the reset gates RG1 and RG2, and selection signals SEL1 and SEL2 are applied to the gates of the selection transistors TSL1 and TSL2. The first through fourth photogate signals SPGA through SPGD correspond to the demodulation signals with different phases described above.

The photogate signals SPGA through SPGD, the overflow gate voltage VOG, the demodulation transfer control signals STGA through STGD, the storage control signals SSG1 and SSG2, the FD transfer control signals STG1 and STG2, the reset signals SRG1 and SRG2, and the selection signals SEL1 and SEL2 may be provided from the row scanning circuit 130 under control of the controller 150 as described above with reference to FIG. 4.

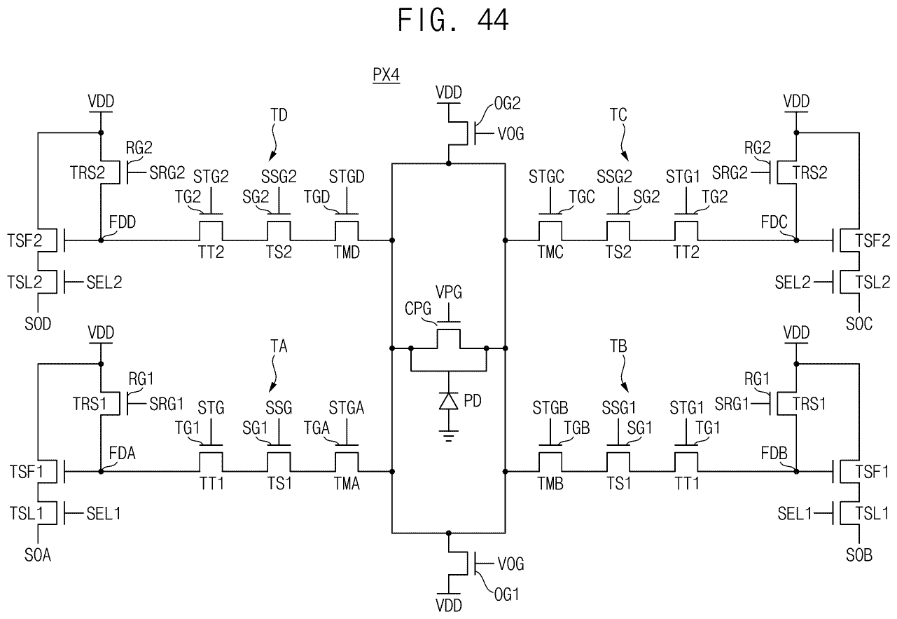

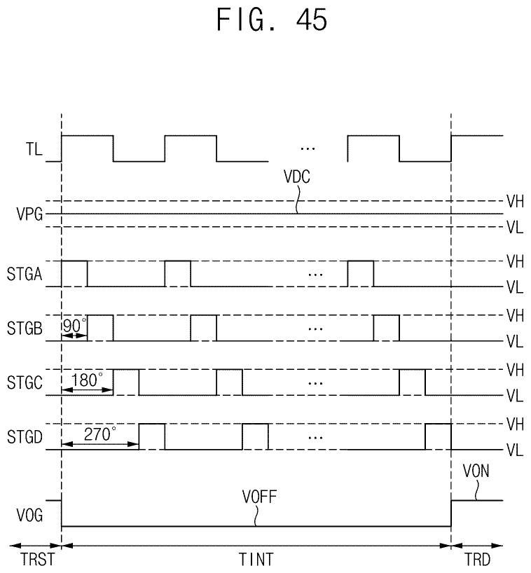

FIG. 44 is a circuit diagram illustrating a depth pixel having a four-tap structure included in a ToF sensor according to example embodiments, and FIG. 45 is a timing diagram illustrating an operation of a ToF sensor including the depth pixel of FIG. 44 according to example embodiments. A depth pixel PX4 of FIG. 44 is similar to the depth pixel PX3 of FIG. 43, and the descriptions repeated with FIG. 43 may be omitted.

Referring to FIG. 44, the depth pixel PX4 includes a common photogate CPG that replaces the first through fourth photogates PGA through PGD of the depth pixel PX3 of FIG. 43.

Referring to FIGS. 44 and 45, during an integration period TINT, a photogate voltage VPG applied to the common photogate CPG may have a DC voltage level VDC that causes collecting of the photo charge. The overflow gate voltage VOG applied to the overflow gates OG1 and OG2 may have a turn-off voltage level VOFF that causes draining of the photo charge to be blocked. The DC voltage level VDC may be a voltage level between a first predetermined (e.g., high) voltage level VH of the demodulation transfer control signals STGA through STGD and a second predetermined (e.g., low) voltage level VL of the demodulation transfer control signals STGA through STGD. In addition, during the integration period TINT, the first through fourth demodulation transfer control signals STGA through STGD of different phases may be applied to the first through fourth demodulation transfer gates TGA through TGD, respectively. In case of the depth pixel PX4 of FIG. 44, the first through fourth demodulation transfer control signals STGA through STGD correspond to the demodulation signals described above. In an example embodiment, the phase difference between the first and second demodulation transfer control signals STGA and STGB may be about 90 degrees, the phase difference between the first and third demodulation transfer control signals STGA and STGC may be about 180 degrees, and the phase difference between the first and fourth demodulation transfer control signals STGA and STGD may be about 270 degrees.

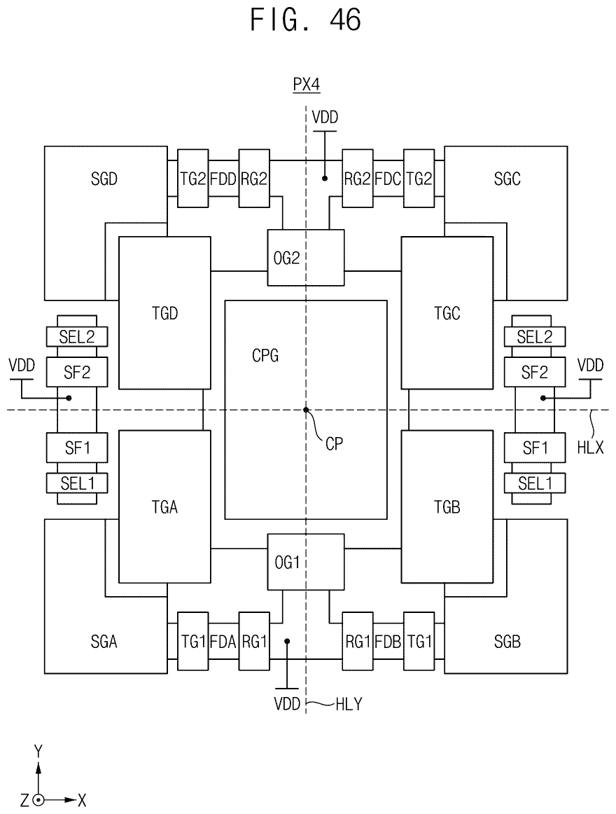

FIG. 46 is a diagram illustrating a layout of the depth pixel of FIG. 44 according to example embodiments.

Referring to FIG. 46, the depth pixel PX4 may include transistors TMA, TS1 and TT1 corresponding to a first tap TA, transistors TMB, TS1 and TT1 corresponding to a second tap TB, transistors TMC, TS2 and TT2 corresponding to a third tap TC, transistors TMD, TS2 and TT2 corresponding to a fourth tap TD, transistors TRS1, TRS2, TSF1, TSF2, TSL1 and TSL2 corresponding to a readout circuit, and a common photogate CPG, overflow gates OG1 and OG2, and a photodiode PD corresponding to a shared circuit.

Each of the transistors TMA, TMB, TMC, TMD, TS1, TS2, TT1, TT2, TRS1 and TRS2 may include a gate disposed on an upper portion of a semiconductor substrate, and a source region and a drain region formed on an upper portion of the semiconductor substrate on both sides of the gate. The gates of the transistors TMA, TMB, TMC, TMD, TS1, TS2, TT1, TT2, TRS1 and TRS2 correspond to a first demodulation transfer gate TGA, a second demodulation transfer gate TGB, a third demodulation transfer gate TGC, a fourth demodulation transfer gate TGD, storage gates SG1 and SG2, second transfer gates TG1 and TG2, and reset gates RG1 and RG2, respectively.

A photogate voltage VPG is applied to the common photogate CPG, an overflow gate voltage VOG is applied to the overflow gates OG1 and OG2, storage control signals SSG1 and SSG2 are applied to the storage gates SG1 and SG2, FD transfer control signals STG1 and STG2 are applied to the second transfer gates TG1 and TG2, reset signals RG1 and RG2 are applied to the reset gates RG1 and RG2, and selection signals SEL1 and SEL2 are applied to the gates of selection transistors TSL1 and TSL2. The first demodulation transfer control signal STGA, the second demodulation transfer control signal STGB, the third demodulation transfer control signal STGC, and the fourth demodulation transfer control signal STGD having different phases are applied to the first demodulation transfer gate TGA, the second demodulation transfer gate TGB, the third demodulation transfer gate TGC, and the fourth demodulation transfer gate TGD, respectively.

The photogate voltage VPG, the overflow gate voltage VOG, the storage control signals SSG1 and SSG2, the FD transfer control signals STG1 and STG2, the reset signals RG1 and RG2, the selection signals SEL1 and SEL2, and the first to fourth demodulation transfer control signals STGA, STGB, STGC and STGD may be provided from the row scan circuit 130 under control of the controller 150 in FIG. 4.

The storage gates SG1 and SG2 are one of the charge storage structures and may temporarily store charge before transferring the charge to the floating diffusion regions FDA, FDB, FDC and FDD through the demodulation transfer gates TGA, TGB, TGC and TGD. In an example embodiment, the charge storage structure may be implemented by the storage gates SG1 and SG2 alone. In another example embodiment, the charge storage structure may be implemented by a structure in which a storage diode is additionally formed in a semiconductor substrate under the storage gates SG1 and SG2. In this way, by including the charge storage structure within the depth pixel PX4, accurate CDS (Correlated Double Sampling) operation may be enabled, such that read noise may be minimized.

Charge stored in the floating diffusion regions FDA, FDB, FDC and FDD may be provided as output signals VOUTA, VOUTB, VOUTC and VOUTD through the transistors TSF1 and TSF2 and the selection transistors TSL1 and TSL2 that perform the role of a source follower buffer amplifier.

As illustrated in FIG. 46, the common photogate CPG is arranged in a central region, and the demodulation transfer gates TGA, TGB, TGC and TGD and the overflow gates OG1 and OG2 have a symmetrical structure with respect to the common photogate CPG. The demodulation transfer gates TGA, TGB, TGC and TGD are arranged symmetrically with respect to each of a first horizontal line HLX and a second horizontal line HLY that pass through the center CP of the depth pixel PX4 and are perpendicular to each other. In other words, the first demodulation transfer gate TGA and the third demodulation transfer gate TGC are symmetrical with respect to the center of the depth pixel PX4, and the second demodulation transfer gate TGB and the fourth demodulation transfer gate TGD are symmetrical with respect to the center of the depth pixel PX4. In addition, the overflow gates OG1 and OG2 are symmetrically arranged with respect to each of the first horizontal line HLX and the second horizontal line HLY Through this symmetrical structure, the characteristic deviation between the plurality of taps may be reduced and the sensing accuracy of the depth pixel may be improved.

According to example embodiments, the first floating diffusion region FDA corresponding to the first tap and the second floating diffusion region FDB corresponding to the second tap may be electrically connected to each other through a conductive path, and the third floating diffusion region FDC corresponding to the third tap and the fourth floating diffusion region FDD corresponding to the fourth tap may be electrically connected to each other through a conductive path. The conductive paths may include vertical contacts such as conductive lines and vias formed on a conductive layer on an upper portion of a semiconductor substrate. In this case, the same demodulation transfer control signal having a first phase may be applied to a first demodulation transfer gate TGA corresponding to a first tap and a second demodulation transfer gate TGB corresponding to a second tap, and the same demodulation transfer control signal having a second phase different from the first phase may be applied to a third demodulation transfer gate TGC corresponding to a third tap and a fourth demodulation transfer gate TGD corresponding to a fourth tap. In this way, by electrically connecting at least two floating diffusion regions among a plurality of floating diffusion regions to each other, the sensing sensitivity of the depth pixel may be increased.

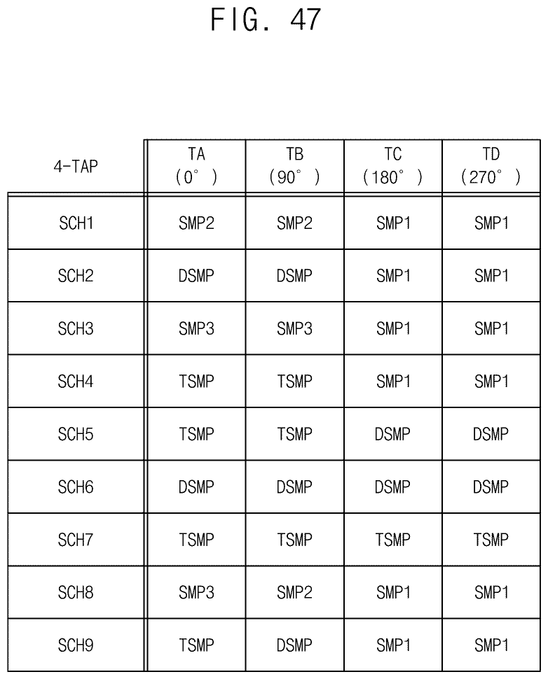

FIG. 47 is a diagram illustrating sampling operations applicable to a depth pixel having a four-tap structure included in a ToF sensor according to example embodiments.

FIG. 47 illustrates first to ninth schemes SCH1 to SCH9 corresponding to example combinations of sampling operations, and the present invention is not limited thereto. As described above with reference to FIGS. 43 through 45, the depth pixel may have a four-tap structure in which a first tap TA operating based on a first demodulation signal SPGA or a first demodulation transfer control signal STGA having a phase difference of 0 degrees from the transmission light TL, a second tap TB operating based on a second demodulation signal SPGB or a second demodulation transfer control signal STGB having a phase difference of 90 degrees from the transmission light TL, a third tap TC operating based on a third demodulation signal SPGC or STGC having a phase difference of 180 degrees from the transmission light TL, and a fourth tap TD operating based on a fourth demodulation signal SPGD or a fourth demodulation transfer control signal STGD having a phase difference of 270 degrees from the transmission light TL are connected to one photodiode PD.

FIG. 47 illustrates various combinations of a first sampling operation SMP1, a second sampling operation SMP2, a third sampling operation SMP3, a double sampling operation DSMP, and a triple sampling operation TSMP, which are applied to the first tap TA, the second tap TB, the third tap TC, and the fourth tap TD during the unit readout cycle 1H of FIGS. 9 to 38, respectively. The first sampling operation SMP1 is as described with reference to FIGS. 9 to 12, the second sampling operation SMP2 is as described with reference to FIGS. 13 to 16, the third sampling operation SMP3 is as described with reference to FIGS. 17 to 19, the double sampling operation DSMP is as described with reference to FIGS. 20 to 24, and the triple sampling operation TSMP is as described with reference to FIGS. 25 to 38, and therefore, redundant descriptions are omitted.

For example, according to the first scheme SCH1, during a unit readout cycle 1H, a second sampling operation SMP2 may be performed with respect to the first tap TA and the second tap TB, and the first sampling operation SMP1 may be performed with respect to the third tap TB and the fourth tap TD. As described above, when applying correlated double sampling (CDS), the first sampling operation SMP1 may include the first data sampling operation DSAM1 and the first reset sampling operation RSAM1, and the second sampling operation SMP2 may include the second data sampling operation DSAM2 and the second reset sampling operation RSAM2.

For example, according to the second scheme SCH2, during the unit readout cycle 1H, the double sampling operation DSMP may be performed with respect to the first tap TA and the second tap TB, and the first sampling operation SMP1 may be performed with respect to the third tap TB and the fourth tap TD. As described above, when applying correlated double sampling (CDS), the double sampling operation DSMP may include the first data sampling operation DSAM1, the first reset sampling operation RSAM1, the second data sampling operation DSAM2, and the second reset sampling operation RSAM2.

For example, according to the third scheme SCH3, during the unit readout cycle 1H, the third sampling operation SMP3 may be performed with respect to the first tap TA and the second tap TB, and the first sampling operation SMP1 may be performed with respect to the third tap TB and the fourth tap TD.

For example, according to the fourth scheme SCH4, during the unit readout cycle 1H, the triple sampling operation TSMP may be performed with respect to the first tap TA and the second tap TB, and the first sampling operation SMP1 may be performed with respect to the third tap TC and the fourth tap TD. As described above, when applying correlated double sampling (CDS), the triple sampling operation TSMP may include the first data sampling operation DSAM1, the first reset sampling operation RSAM1, the second data sampling operation DSAM2, the second reset sampling operation RSAM2, the third data sampling operation DSAM3, and the third reset sampling operation RSAM3.

For example, according to the fifth scheme SCH5, during the unit readout cycle 1H, the triple sampling operation TSMP may be performed with respect to the first tap TA and the second tap TB, and the double sampling operation SMP1 may be performed with respect to the third tap TC and the fourth tap TD.

Referring again to FIG. 4, the reception light RL reflected from the object OBJ and incident on the depth pixel of the ToF sensor 100 is roughly inversely proportional to the square of the distance between the depth pixel and the object OBJ. Therefore, when the object OBJ is close to the ToF sensor 100, the first tap TA and the second tap TB sense the reception light RL of relatively high intensity, and the third tap TC and the fourth tap TD sense the reception light RL of relatively low intensity. Therefore, as in the first to fifth schemes SCH1 to SCH5, a sampling operation corresponding to a relatively small conversion gain may be applied to the first tap TA and the second tap TB, and a sampling operation corresponding to a relatively greater conversion gain may be applied to the third tap TC and the fourth tap TD.

According to example embodiments, as in the sixth and seventh schemes SCH6 and SCH7, the same sampling operation may be applied to the first through fourth taps TA through TD. In addition, as in the eighth and ninth schemes SCH8 and SCH9, various sampling operations may be applied tap by tap.

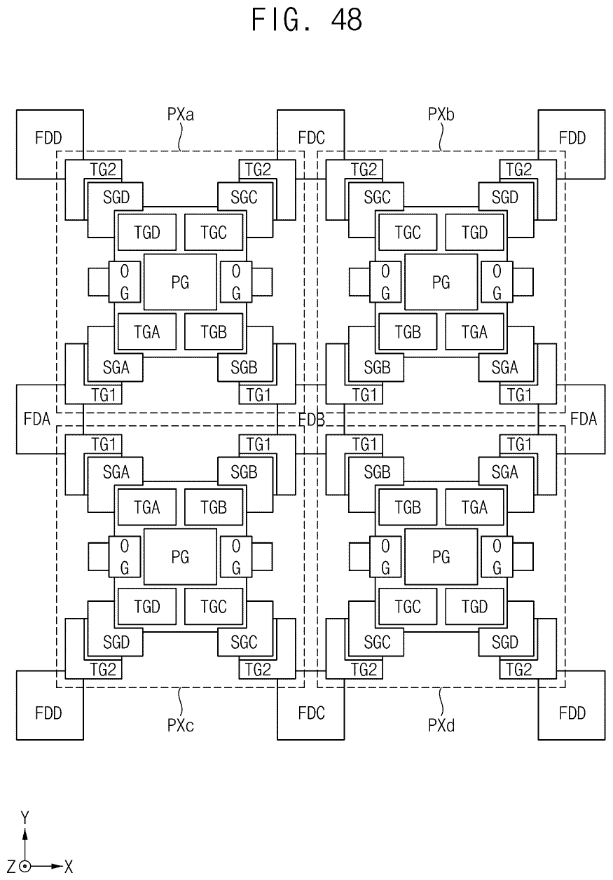

FIG. 48 is a diagram illustrating sharing a floating diffusion region of depth pixels included in a ToF sensor according to example embodiments.

For convenience of illustration, in FIG. 48, four depth pixels PXa, PXb, PXc, and PXd adjacent in a first horizontal direction X and a second horizontal direction Y are illustrated, but more depth pixels may be arranged in the same way in the pixel array (110) of FIG. 4.

Referring to FIG. 48, the four adjacent depth pixels PXa, PXb, PXc and PXd may share one floating diffusion region. For example, taps adjacent to one floating diffusion region FDB corresponding to the second tap and included in each of the four depth pixels PXa, PXb, PXc and PXd may all be taps corresponding to demodulation signal of the same phase. In other words, the second demodulation signal having the same phase is applied to four second demodulation transfer gates TGB included in each of the four depth pixels PXa, PXb, PXc and PXd, and photo charge corresponding to the second demodulation transfer control signal collected by the four depth pixels PXa, PXb, PXc and PXd may be combined in the central floating diffusion region FDB. In this way, the photo charge collected by the adjacent four pixels may be combined in each of the first shared floating diffusion region FDA corresponding to the first tap, the second shared floating diffusion region FDB corresponding to the second tap, the third shared floating diffusion region FDC corresponding to the third tap, and the fourth shared floating diffusion region FDD corresponding to the fourth tap. In this way, the sensing sensitivity of the depth pixel may be increased through the structure in which the plurality of depth pixels share the floating diffusion region.

As described above, the ToF sensor and the method of operating the ToF sensor according to example embodiments may efficiently implement the plurality of conversion gains without increase in the occupation area of the depth pixel and the ToF sensor by controlling the signals or voltages applied to the depth pixel to change the capacitance of the floating diffusion region.

The inventive concept may be applied to any electronic devices and systems including a ToF sensor. For example, the inventive concept may be applied to systems such as a mobile phone, a smart phone, a personal digital assistant (PDA), a portable multimedia player (PMP), a digital camera, a camcorder, a personal computer (PC), a server computer, a workstation, a laptop computer, a digital TV, a set-top box, a portable game console, a navigation system, a wearable device, an internet of things (IoT) device, an internet of everything (IoE) device, an e-book, a virtual reality (VR) device, an augmented reality (AR) device, a server system, an automotive driving system, etc.

The foregoing is illustrative of example embodiments and is not to be construed as limiting thereof. Although a few example embodiments have been described, those skilled in the art will readily appreciate that many modifications are possible in the example embodiments without materially departing from the present invention as set forth in the following claims.

What is claimed is:

1. A method of operating a time-of-flight (ToF) sensor including a depth pixel, wherein the depth pixel includes a plurality of taps configured to operate based on a plurality of demodulation signals having different phases with each other, each tap including a first transfer gate, a storage gate and a second transfer gate that are sequentially arranged between a photodiode and a floating diffusion region, the method comprising:
collecting photo charge in a charge storage structure below the storage gate from the photodiode;
transferring the collected photo charge from the charge storage structure to the floating diffusion region;
performing a first data sampling operation corresponding to a first conversion gain by applying a turn-off voltage to the second transfer gate to set a capacitance of the floating diffusion region to a first capacitance; and
performing a second data sampling operation corresponding to a second conversion gain smaller than the first conversion gain by applying the turn-off voltage to the storage gate and applying a turn-on voltage to the second transfer gate to increase the capacitance of the floating diffusion region to a second capacitance greater than the first capacitance,
wherein the performing of each of the first and second data sampling operations includes:
sensing the photo charge stored in the floating diffusion region as a signal voltage.

2. The method of claim 1, further comprising:
performing a first reset sampling operation corresponding to the first data sampling operation before performing the first data sampling operation; and
performing a second reset sampling operation corresponding to the second data sampling operation after performing the second data sampling operation.

3. The method of claim 1, wherein the depth pixel has a two-tap structure such that the photodiode is connected to:
a first tap configured to operate based on a first demodulation signal having a phase difference of a zero degree with respect to a phase of a transmission light, and
a second tap configured to operate based on a second demodulation signal having the phase difference of 180 degrees with respect to the phase of the transmission light, and
wherein the second data sampling operation is performed with respect to the first tap during a unit readout cycle and the first data sampling operation is performed with respect to the second tap during the unit readout cycle.

4. The method of claim 1, wherein the depth pixel has a four-tap structure such that the photodiode is connected to:
a first tap configured to operate based on a first demodulation signal having a phase difference of a zero degree with respect to a phase of a transmission light,
a second tap configured to operate based on a second demodulation signal having the phase difference of 90 degrees with respect to the phase of the transmission light,
a third tap configured to operate based on a third demodulation signal having the phase difference of 180 degrees with respect to the phase of the transmission light, and
a fourth tap configured to operate based on a fourth demodulation signal having the phase difference of 270 degrees with respect to the phase of the transmission light, and
wherein the second data sampling operation is performed with respect to the first tap and the second tap during a unit readout cycle and the first data sampling operation is performed with respect to the third tap and the fourth tap during the unit readout cycle.

5. The method of claim 1, further comprising:
performing a double sampling operation such that the second data sampling operation and the first data sampling operation after the second data sampling operation are sequentially performed with respect to one tap during one unit readout cycle.

6. The method of claim 5, further comprising:
performing a first reset sampling operation corresponding to the first data sampling operation before the second data sampling operation with respect to the one tap during the one unit readout cycle; and
performing a second reset sampling operation corresponding to the second data sampling operation after the first data sampling operation with respect to the one tap during the one unit readout cycle.

7. The method of claim 5, wherein the depth pixel has a two-tap structure such that the photodiode is connected to:
a first tap configured to operate based on a first demodulation signal having a phase difference of a zero degree with respect to a phase of a transmission light, and
a second tap configured to operate based on a second demodulation signal having the phase difference of 180 degrees with respect to the phase of the transmission light, and
wherein the double sampling operation is performed with respect to the first tap during a unit readout cycle and the first data sampling operation is performed with respect to the second tap during the unit readout cycle.

8. The method of claim 5, wherein the depth pixel has a four-tap structure such that the photodiode is connected to:
a first tap configured to operate based on a first demodulation signal having a phase difference of a zero degree with respect to a phase of a transmission light,
a second tap configured to operate based on a second demodulation signal having the phase difference of 90 degrees with respect to the phase of the transmission light,
a third tap configured to operate based on a third demodulation signal having the phase difference of 180 degrees with respect to the phase of the transmission light, and
a fourth tap configured to operate based on a fourth demodulation signal having the phase difference of 270 degrees with respect to the phase of the transmission light, and
wherein the double sampling operation is performed with respect to the first tap and the second tap during a unit readout cycle and the first data sampling operation is performed with respect to the third tap and the fourth tap during the unit readout cycle.

9. The method of claim 1, further comprising:
performing a third data sampling operation corresponding to a third conversion gain smaller than the second conversion gain by applying the turn-on voltage to the storage gate and applying the turn-on voltage to the second transfer gate to increase the capacitance of the floating diffusion region to a third capacitance greater than the second capacitance.

10. The method of claim 9, further comprising:
performing a triple sampling operation such that the third data sampling operation, the second data sampling operation after the third data sampling operation and the first data sampling operation after the second data sampling operation are sequentially performed with respect to one tap during one unit readout cycle.

11. The method of claim 10, further comprising:
performing a first reset sampling operation corresponding to the first data sampling operation before the third data sampling operation with respect to the one tap during the one unit readout cycle;
performing a third reset sampling operation corresponding to the third data sampling operation after the first data sampling operation with respect to the one tap during the one unit readout cycle; and
performing a second reset sampling operation corresponding to the second data sampling operation after the third reset sampling operation with respect to the one tap during the one unit readout cycle.

12. The method of claim 10, further comprising:
performing a first reset sampling operation corresponding to the first data sampling operation after the first data sampling operation with respect to the one tap during the one unit readout cycle;
performing a second reset sampling operation corresponding to the second data sampling operation after the first reset sampling operation with respect to the one tap during the one unit readout cycle; and
performing a third reset sampling operation corresponding to the third data sampling operation after the second reset sampling operation with respect to the one tap during the one unit readout cycle.

13. The method of claim 10, wherein the depth pixel has a two-tap structure such that the photodiode is connected to:
a first tap configured to operate based on a first demodulation signal having a phase difference of a zero degree with respect to a phase of a transmission light, and
a second tap configured to operate based on a second demodulation signal having the phase difference of 180 degrees with respect to the phase of the transmission light, and
wherein the triple sampling operation is performed with respect to the first tap during a unit readout cycle and the first data sampling operation is performed with respect to the second tap during the unit readout cycle.

14. The method of claim 10, wherein the depth pixel has a four-tap structure such that the photodiode is connected to:
a first tap configured to operate based on a first demodulation signal having a phase difference of a zero degree with respect to a phase of a transmission light,
a second tap configured to operate based on a second demodulation signal having the phase difference of 90 degrees with respect to the phase of the transmission light,
a third tap configured to operate based on a third demodulation signal having the phase difference of 180 degrees with respect to the phase of the transmission light, and
a fourth tap configured to operate based on a fourth demodulation signal having the phase difference of 270 degrees with respect to the phase of the transmission light, and
wherein the triple sampling operation is performed with respect to the first tap and the second tap during a unit readout cycle and the first data sampling operation is performed with respect to the third tap and the fourth tap during the unit readout cycle.

15. A time-of-flight (ToF) sensor comprising:
a light source configured to emit a transmission light to an object;
a pixel array including a depth pixel, wherein the depth pixel includes a plurality of taps configured to operate based on a plurality of demodulation signals having different phases with respect to a phase of the transmission light, each tap of the plurality of taps including a first transfer gate, a storage gate and a second transfer gate that are sequentially arranged between a photodiode and a floating diffusion region; and
a row scanning circuit configured to:
collect photo charge in a charge storage structure below the storage gate from the photodiode,
transfer the collected photo charge from the charge storage structure to the floating diffusion region,
perform a first data sampling operation corresponding to a first conversion gain by applying a turn-off voltage to the second transfer gate to set a capacitance of the floating diffusion region to a first capacitance, and
perform a second data sampling operation corresponding to a second conversion gain smaller than the first conversion gain by applying the turn-off voltage to the storage gate and applying a turn-on voltage to the second transfer gate to increase the capacitance of the floating diffusion region to a second capacitance greater than the first capacitance,
wherein the row scanning circuit is configured sense the photo charge stored in the floating diffusion region as a signal voltage during the first and second data sampling operations.

16. The ToF sensor of claim 15, wherein the row scanning circuit is configured to:
perform a double sampling operation such that the second data sampling operation and the first data sampling operation after the second data sampling operation are sequentially performed with respect to one tap during one unit readout cycle.

17. The ToF sensor of claim 15, wherein the row scanning circuit is configured to:
perform a third data sampling operation corresponding to a third conversion gain smaller than the second conversion gain by applying the turn-on voltage to the storage gate and applying the turn-on voltage to the second transfer gate to increase the capacitance of the floating diffusion region to a third capacitance greater than the second capacitance.

18. The ToF sensor of claim 17, wherein the row scanning circuit is configured to:
perform a triple sampling operation such that the third data sampling operation, the second data sampling operation after the third data sampling operation and the first data sampling operation after the second data sampling operation are sequentially performed with respect to one tap during one unit readout cycle.

19. The ToF sensor of claim 15, wherein the charge storage structure includes:
a storage diode disposed in a semiconductor substrate below the storage gate.

20. A method of operating a time-of-flight (ToF) sensor including a depth pixel, wherein the depth pixel includes a plurality of taps configured to operate based on a plurality of demodulation signals having different phases with each other, each tap including a first transfer gate, a storage gate and a second transfer gate that are sequentially arranged between a photodiode and a floating diffusion region, the method comprising:
changing a capacitance of the floating diffusion region by controlling voltages applied to the storage gate and the second transfer gate; and
performing a plurality of sampling operations corresponding to a plurality of conversion gains with changing the capacitance of the floating diffusion region,
wherein each tab has one or more conversion gains.
